(19) United States
(12) Patent Application Publication
(10) Pub. No.: US 2025/0216822 A1
(43) Pub. Date: Jul. 3, 2025

(54) CONTROL SYSTEM WITH HIERARCHICAL SYSTEM IDENTIFICATION

(71) Applicant: Imubit Israel Ltd., Modiin (IL)

(72) Inventors: Elhanan Ilani, Jerusalem (IL); Matanya Yechiel Beery, Tzur Hadassah (IL); Yarden Sheffer, Tel Aviv (IL); Nadav Cohen, Yavne (IL)

(73) Assignee: Imubit Israel Ltd., Modiin (IL)

(21) Appl. No.: 18/403,179

(22) Filed: Jan. 3, 2024

(51) Int. Cl. G05B 13/04; G05B 13/02

(52) U.S. Cl. CPC G05B 13/048; G05B 13/0265

(57) ABSTRACT

A predictive control system for a plant includes a model generator and a controller. The model generator is configured to train a subprocess model representing a subprocess of the plant using historical values of forecast variables and manipulated variables. The model generator is further configured to train a main process model representing a main process of the plant using historical values of controlled variables, forecast variables, and manipulated variables. The controller is configured to execute a predictive control process using the subprocess model and the main process model to control operation of the plant. The predictive control process includes using the subprocess model to predict future values of the forecast variables, using the main process model to predict future values of the controlled variables based on the predicted future values of the forecast variables, and controlling operation of the plant based on the predicted future values of the controlled variables.

### BACKGROUND

The present disclosure relates generally to a control system for a plant (e.g., an oil refinery) including one or more controllable systems or processes (e.g., oil refining equipment such as an atmospheric distillation unit, vacuum distillation unit, coker, fluid catalytic cracker unit, etc.). The present disclosure relates more particularly to predictive control systems that generate predictive models by performing system identification and use the predictive models to generate control signals for controllable systems or processes.

System identification is the process of generating a system model that allows for the prediction of future system states or system outputs. Because the physical phenomena that govern some systems are often complex, nonlinear, and poorly understood, it may be difficult to construct “white-box” or “first-principles” models for such systems. Accordingly, system identification can be used to generate or train a system model (e.g., determine values for model parameters, weights, etc.) based on measured and recorded data from the real system and any external influences (e.g., controllable inputs to the system, uncontrolled disturbances, etc.). System identification can be performed using a variety of different methods including, for example, “black-box” methods in which a system is viewed in terms of its inputs and outputs without requiring any knowledge of its inner workings or “gray-box” methods in which the system model is based on both insight into the system and experimental data. The data set used to perform the system identification process is often referred to as training data and may include historical data gathered from the system or other data sources.

In some cases, system identification starts by using an initial or untrained version of the system model to predict future states or outputs of the system given the initial state of the system and a set of inputs to the system over time. The predictions from the model can be compared to actual data from the system (e.g., historical data) during an offline learning process and the error between the model predictions and the actual data can be evaluated. The model parameters can be adjusted and the process repeated (e.g., iteratively) until the model predictions closely align with the actual data. A variety of different techniques for adjusting the model parameters to reduce model error are known in the art. However, regardless of the technique used, it can be difficult to learn the relationship between the inputs to the system and the system states or outputs due to the presence of noise (e.g., measurement noise, process noise, etc.). The systems and methods of the present disclosure address this challenge.

### SUMMARY

One implementation of the present disclosure is a predictive control system for a plant represented as a subprocess and a main process affected by the subprocess. The predictive control system includes a model generator and a controller. The model generator is configured to obtain historical values of one or more forecast variables representing one or more outputs of the subprocess, historical values of one or more controlled variables representing one or more outputs of the main process, and historical values of one or more manipulated variables representing one or more inputs to the plant. The model generator is further configured to train a subprocess model representing the subprocess using the historical values of the one or more forecast variables and the historical values of the one or more manipulated variables. The model generator is further configured to train a main process model representing the main process using the historical values of the one or more controlled variables, the historical values of the one or more forecast variables, and the historical values of the one or more manipulated variables. The controller is configured to execute a predictive control process using the subprocess model and the main process model to control operation of the plant. The predictive control process includes using the subprocess model to predict future values of the one or more forecast variables based on values of the one or more manipulated variables, using the main process model to predict future values of the one or more controlled variables based on the future values of the one or more forecast variables predicted by the subprocess model, and controlling operation of the plant based on the future values of the one or more controlled variables predicted by the main process model.

In some embodiments, the model generator is configured to independently train the main process model without using predictions generated by the subprocess model and the controller is configured to use the predictions generated by the subprocess model as inputs to the main process model when executing the predictive control process.

In some embodiments, controlling operation of the plant includes evaluating a reward function using the future values of the one or more controlled variables predicted by the main process model, adjusting the values of the one or more manipulated variables to drive the reward function toward an extremum, and using the adjusted values of the one or more manipulated variables to control operation of the plant.

In some embodiments, the plant includes a plurality of subprocesses and a plurality of main processes affected by the plurality of subprocesses, the model generator is configured to train a plurality of subprocess models representing the plurality of subprocesses and a plurality of main process models representing the plurality of main processes, and the controller is configured to use the plurality of subprocess models to predict future values of the one or more forecast variables representing outputs of the plurality of subprocesses and use the plurality of main process models to predict future values of the one or more controlled variables representing outputs of the plurality of main processes.

In some embodiments, the plurality of subprocesses are arranged in series with each other such that an output of a first subprocess of the plurality of subprocesses is provided as an input to a second subprocess of the plurality of subprocesses. In some embodiments, the controller is configured to use a first subprocess model of the plurality of subprocess models representing the first subprocess to predict future values of one or more first forecast variables representing one or more outputs of the first subprocess based on the values of the one or more manipulated variables, use a second subprocess model of the plurality of subprocess models representing the second subprocess to predict future values of one or more second forecast variables representing one or more outputs of the second subprocess based on the future values of the one or more first forecast variables predicted by the first subprocess model, and use the main process model to predict future values of the one or more controlled variables based on the future values of the one or more second forecast variables predicted by the second subprocess model.

In some embodiments, the plurality of subprocesses are arranged in parallel with each other such that a first output of a first subprocess of the plurality of subprocesses and a second output of a second subprocess of the plurality of subprocesses are provided as inputs to the main process. In some embodiments, the controller is configured to use a first subprocess model of the plurality of subprocess models representing the first subprocess to predict future values of one or more first forecast variables representing one or more outputs of the first subprocess based on the values of the one or more manipulated variables, use a second subprocess model of the plurality of subprocess models representing the second subprocess to predict future values of one or more second forecast variables representing one or more outputs of the second subprocess based on the values of the one or more manipulated variables, and use the main process model to predict future values of the one or more controlled variables based on the future values of the one or more first forecast variables predicted by the first subprocess model and the future values of the one or more second forecast variables predicted by the second subprocess model.

In some embodiments, controlling operation of the plant includes using the values of the one or more controlled variables predicted by the main process model to train a controller neural network model during an offline training phase of the predictive control process and using the controller neural network model to generate values of the one or more manipulated variables during an online operation phase of the predictive control process.

Another implementation of the present disclosure is a method for controlling operation of a plant represented as a subprocess and a main process affected by the subprocess. The method includes obtaining historical values of one or more forecast variables representing one or more outputs of the subprocess, historical values of one or more controlled variables representing one or more outputs of the main process, and historical values of one or more manipulated variables representing one or more inputs to the plant. The method includes training a subprocess model representing the subprocess using the historical values of the one or more forecast variables and the historical values of the one or more manipulated variables. The method includes training a main process model representing the main process using the historical values of the one or more controlled variables, the historical values of the one or more forecast variables, and the historical values of the one or more manipulated variables. The method includes executing a predictive control process using the subprocess model and the main process model to control operation of the plant. The predictive control process includes using the subprocess model to predict future values of the one or more forecast variables based on values of the one or more manipulated variables, using the main process model to predict future values of the one or more controlled variables based on the future values of the one or more forecast variables predicted by the subprocess model, and controlling operation of the plant based on the future values of the one or more controlled variables predicted by the main process model.

In some embodiments, the main process model and the subprocess model are trained independently without using predictions generated by the subprocess model when training the main process model. In some embodiments, the predictions generated by the subprocess model are used as inputs to the main process model when executing the predictive control process.

In some embodiments, controlling operation of the plant includes evaluating a reward function using the future values of the one or more controlled variables predicted by the main process model, adjusting the values of the one or more manipulated variables to drive the reward function toward an extremum, and using the adjusted values of the one or more manipulated variables to control operation of the plant.

In some embodiments, the plant includes a plurality of subprocesses and a plurality of main processes affected by the plurality of subprocesses, training the subprocess model includes training a plurality of subprocess models representing the plurality of subprocesses, training the main process model includes training a plurality of main process models representing the plurality of main processes, and controlling operation of the plant includes using the plurality of subprocess models to predict future values of the one or more forecast variables representing outputs of the plurality of subprocesses and using the plurality of main process models to predict future values of the one or more controlled variables representing outputs of the plurality of main processes.

In some embodiments, the plurality of subprocesses are arranged in series with each other such that an output of a first subprocess of the plurality of subprocesses is provided as an input to a second subprocess of the plurality of subprocesses. In some embodiments, predictive control process includes using a first subprocess model of the plurality of subprocess models representing the first subprocess to predict future values of one or more first forecast variables representing one or more outputs of the first subprocess based on the values of the one or more manipulated variables, using a second subprocess model of the plurality of subprocess models representing the second subprocess to predict future values of one or more second forecast variables representing one or more outputs of the second subprocess based on the future values of the one or more first forecast variables predicted by the first subprocess model, and using the main process model to predict future values of the one or more controlled variables based on the future values of the one or more second forecast variables predicted by the second subprocess model.

In some embodiments, the plurality of subprocesses are arranged in parallel with each other such that a first output of a first subprocess of the plurality of subprocesses and a second output of a second subprocess of the plurality of subprocesses are provided as inputs to the main process. In some embodiments, the predictive control process includes using a first subprocess model of the plurality of subprocess models representing the first subprocess to predict future values of one or more first forecast variables representing one or more outputs of the first subprocess based on the values of the one or more manipulated variables, using a second subprocess model of the plurality of subprocess models representing the second subprocess to predict future values of one or more second forecast variables representing one or more outputs of the second subprocess based on the values of the one or more manipulated variables, and using the main process model to predict future values of the one or more controlled variables based on the future values of the one or more first forecast variables predicted by the first subprocess model and the future values of the one or more second forecast variables predicted by the second subprocess model.

In some embodiments, controlling operation of the plant includes using the values of the one or more controlled variables predicted by the main process model to train a controller neural network model during an offline training phase of the predictive control process and using the controller neural network model to generate values of the one or more manipulated variables during an online operation phase of the predictive control process.

Another implementation of the present disclosure is a predictive control system for a plant represented as a subprocess and a main process affected by the subprocess. The predictive control system includes one or more processing circuits configured to independently train a subprocess model representing the subprocess and a main process model representing the main process without using predictions generated by the subprocess model when training the main process model. After independently training the subprocess model and the main process model, the predictive control system is configured to connect the subprocess model to the main process model such that the predictions generated by the subprocess model are provided as inputs to the main process model. The predictive control system is configured to execute a predictive control process using the subprocess model to generate predicted values of one or more forecast variables and using the main process model to generate predicted values of one or more controlled variables based on the predicted values of the one or more forecast variables generated by the subprocess model and control operation of the plant using the predicted values of the one or more controlled variables generated by the main process model.

In some embodiments, training the subprocess model includes using historical values of one or more manipulated variables to generate predicted historical values of the one or more forecast variables using the subprocess model and adjusting the subprocess model to reduce an error between the predicted historical values of the forecast variables and actual historical values of the forecast variables.

In some embodiments, training the main process model includes using historical values of the one or more forecast variables and historical values of one or more manipulated variables to generate predicted historical values of the one or more controlled variables using the main process model and adjusting the main process model to reduce an error between the predicted historical values of the controlled variables and actual historical values of the controlled variables.

In some embodiments, controlling operation of the plant includes evaluating a reward function using the predicted values of the one or more controlled variables generated by the main process model, adjusting values of one or more manipulated variables provided as inputs to the plant to drive the reward function toward an extremum, and using the adjusted values of the one or more manipulated variables to control operation of the plant.

In some embodiments, training the subprocess model and the main process model includes independently training a plurality of subprocess models representing a plurality of subprocesses of the plant and a plurality of main process models representing a plurality of main processes of the plant. In some embodiments, connecting the subprocess model to the main process model includes connecting a first subprocess model of the plurality of subprocess models and a second subprocess model of the plurality of subprocess models in series with each other and with one or more of the plurality of main process models such that a first output of the first subprocess model is provided as an input to the second subprocess model and a second output of the second subprocess model is provided as an input to the one or more of the plurality of main process models.

In some embodiments, training the subprocess model and the main process model includes independently training a plurality of subprocess models representing a plurality of subprocesses of the plant and a plurality of main process models representing a plurality of main processes of the plant. In some embodiments, connecting the subprocess model to the main process model includes connecting a first subprocess model of the plurality of subprocess models and a second subprocess model of the plurality of subprocess models in parallel with each other and in series with one or more of the plurality of main process models such that a first output of the first subprocess model is provided as a first input to the one or more of the plurality of main process models and a second output of the second subprocess model is provided as a second input to the one or more of the plurality of main process models.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of a control system including a plant, a controller, a historical database, and a model generator, according to an exemplary embodiment.

FIG. 2 is a block diagram illustrating the plant and controller of FIG. 1 in greater detail, according to a first exemplary embodiment in which the plant is represented as a main process and a single subprocess which affects the main process.

FIG. 3 is a block diagram illustrating the plant and controller of FIG. 1 in greater detail, according to a second exemplary embodiment in which the plant is represented as a main process and a plurality of subprocess arranged in series with each other.

FIG. 4 is a block diagram illustrating the plant and controller of FIG. 1 in greater detail, according to a third exemplary embodiment in which the plant is represented as a main process and a plurality of subprocesses arranged in parallel with each other.

FIGS. 5A-5C are block diagrams illustrating various potential arrangements of subprocesses and main processes within the plant of FIG. 1 in greater detail.

FIG. 6 is a block diagram illustrating the model generator of FIG. 1 in greater detail, according to an exemplary embodiment.

FIG. 7 is a flowchart of a hierarchical system identification process which can be performed by the control system of FIG. 1, according to an exemplary embodiment.

### DETAILED DESCRIPTION

### Overview

Referring generally to the FIGURES, control systems and methods with hierarchical system identification are shown, according to various exemplary embodiments. The systems and methods described herein can be used to generate or train predictive models of a plant (e.g., a controlled system or process) during an offline training phase and then use the predictive models to control online operation of the plant. In some embodiments, the systems and methods of the present disclosure can be used to monitor and control a plant which can be represented as a main process and one or more subprocesses that affect the main process. Separate predictive models can be independently generated for the main process and each of the subprocesses during the offline training phase. After training is complete, the one or more subprocess models can be connected to the main process model such that the output of the one or more subprocess models is provided as input to the main process model during online operation.

In some embodiments, the subprocess model has the form fₜ₊₁=F(fₜ, uₜ) and the main process model has the form cₜ₊₁=C(cₜ, fₜ, uₜ) where cₜ₊₁ denotes the values of the controlled variables (CVs) at time t+1, cₜ denotes the values of the CVs at time t, fₜ denotes the values of the forecast variables (FVs) at time t, fₜ₊₁ denotes the values of the FVs at time t+1, uₜ denotes the values of the control actions (e.g., manipulated variables (MVs) such as control signals, operating commands, setpoints, control inputs, etc.) at time t, C is a function that represents how the CVs evolve over time as a function of the inputs to the main process and F is a function that represents how FVs evolve over time as a function of inputs to the subprocess. It is evident from these equations that the values of the CVs are affected by the values of the FVs, but the values of the CVs do not affect the values of the FVs. This unidirectional causal relationship is referred to as hierarchical throughout the present disclosure. System identification can be performed to learn the functions F and C that define the subprocess model and the main process model respectively.

System identification is the process of generating a system model that allows for the prediction of future system states or system outputs. The classical problem of system identification involves predicting a future state xₜ₊₁ of a plant (e.g., a controlled system or process) given the existing state xₜ of the plant and the control action uₜ provided as an input to the plant. Historical data of the state xₜ and control action uₜ over a given time period can be used to generate a predictive model. However, the relation xₜ₊₁ (xₜ, uₜ) can be difficult to learn directly due to the presence of noise. In that case, it is useful to predict a finite horizon of the resulting states. That is, given an initial state xₜ and the control actions u₀, . . . , uₙ₋₁, predict all states x₁, . . . , xₙ.

The state xₜ of the plant at time t can be defined as the states of the FVs and the CVs at time t. That is, xₜ=(fₜ, cₜ). As noted above, the FVs and CVs have a unidirectional causal relationship (referred to herein as a hierarchical relationship) such that the values of the CVs depend on the values of the FVs, but the values of the FVs do not depend on the values of the CVs. This hierarchical relationship can be leveraged to address an issue that arises in system identification which might lead to compromised predictions of the CVs in some scenarios if not appropriately handled. For example, if the function cₜ₊₁=C(cₜ, fₜ, uₜ) is trained using the values of the FVs generated by the subprocess model instead of historical values of the FVs (i.e., actual values of the FVs during a historical time period), the function C would not account for unpredictable process noise ξ in the subprocess which causes the historical values of the FVs to deviate from the values of the FVs predicted by the subprocess model. As an example, in the case where fₜ₊₁=F(fₜ, uₜ)+ ξ where F is a function and ξ is unpredictable process noise in the subprocess, even if the subprocess model learns the function F perfectly, the values of fₜ predicted by the subprocess model will not be the same as those in the historical data because the values of fₜ predicted by the subprocess model do not account for the unpredictable process noise ξ. Accordingly, training the main process model using values of fₜ predicted by the subprocess model instead of the actual values of fₜ in the historical data might lead to the main process model learning an incorrect relationship between fₜ and cₜ.

Advantageously, the systems and methods of the present disclosure can be configured to train the main process model and the subprocess model in a manner that leverages the hierarchical or causal structure of the corresponding processes in the plant. For example, a model trainer can be configured to independently train the main process model and the subprocess model using the historical data, rather than using the predicted values of the FVs from the subprocess model to train the main process model. The training process can be performed offline using the historical data. Once the main process model and the subprocess model are trained, the trained models can be provided to an online controller and used for process prediction during online or real-time operation of the plant. During online operation, the predicted values of the FVs from the subprocess model can be provided as inputs to the main process model, whereas during the offline training phase both models are trained independently from the historical data. These and other features are described in greater detail below.

### Hierarchical System Identification and Control System

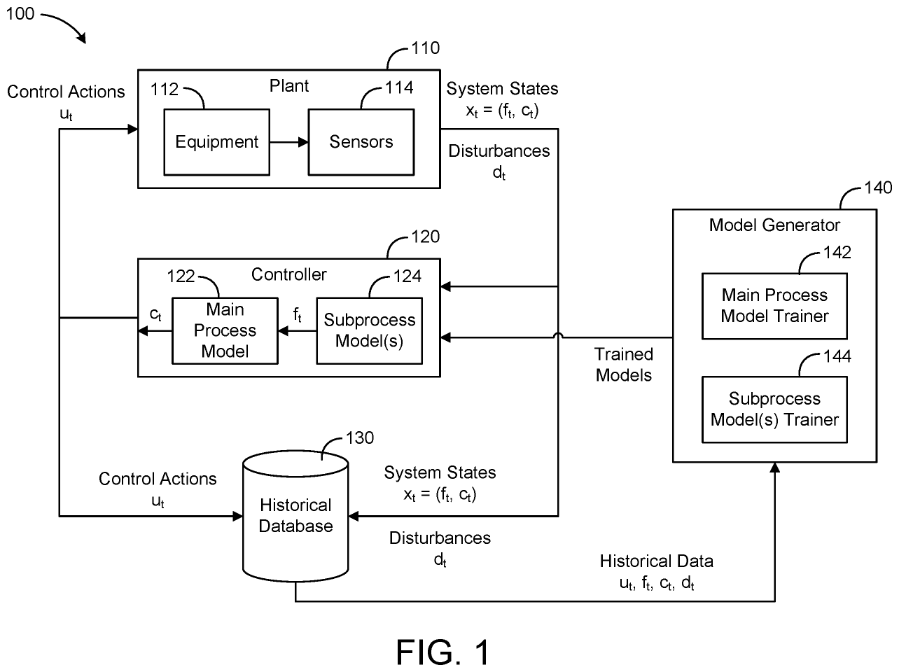

Referring now to FIG. 1, a block diagram of a control system 100 is shown, according to an exemplary embodiment. Control system 100 is shown to include a plant 110, a controller 120, a historical database 130, and a model generator 140. A plant in control theory is the combination of a process and controllable equipment capable of affecting the process. Plant 110 can include any type of controllable system or process. In some embodiments, plant 110 includes an oil refinery system which operates to transform crude oil or other crude petroleum products into more useful products such as gasoline, petrol, kerosene, jet fuel, etc. Several examples of oil refinery systems which can be used as plant 110 are described in detail in U.S. patent application Ser. No. 16/888,128 filed May 29, 2020, U.S. patent application Ser. No. 16/950,643 filed Nov. 17, 2020, U.S. patent application Ser. No. 17/308,474 filed May 5, 2021, U.S. patent application Ser. No. 17/384,660 filed Jul. 23, 2021, and U.S. patent application Ser. No. 17/831,227 filed Jun. 2, 2022, all of which are incorporated by reference herein in their entireties. However, it should be understood that plant 110 is not limited to oil refinery systems and can include any of a wide variety of controllable systems or processes (e.g., mechanical processes, chemical processes, electrical processes, manufacturing processes, etc.) across a variety of different industries or applications.

Plant 110 is shown to include equipment 112 and sensors 114. Equipment 112 can include any type of controllable equipment capable of affecting the process represented by plant 110. Examples of equipment 112 include valves, actuators, pumps, fans, burners, chillers, robotic assemblies, mixers, or any other type of equipment. The particular type or types of equipment 112 included in plant 110 depends on the type of controllable system or process and may include any type of equipment 112 suitable for use in that system or process. For example, in an oil refinery system, equipment 112 may include oil tanks, atmospheric distillation units (ADUs), vacuum distillation units (VDUs), coker subsystems, fluid catalytic cracker units (FCCUs), hydrocracking units (HUs), or any other type of equipment suitable for oil refinery operations.

Sensors 114 can include any of a wide variety of sensors (e.g., meters, measurement devices, sensing devices, etc.) capable of monitoring the controllable system or process represented by plant 110. For example, sensors 114 can include temperature sensors, pressure sensors, weight sensors, chemical sensors, motion sensors, proximity sensors, magnetic sensors, ultrasonic transducers, capacitive sensors, light sensors, or any other type of sensor capable of measuring a variable state or condition of plant 110. The state of plant 110 at a given time t can be represented by a state vector xₜ which includes values of forecast variables (FVs) and controlled variables (CVs), denoted as fₜ and cₜ respectively (i.e., xₜ=(fₜ, cₜ)). In some embodiments, sensors 114 directly measure the values of the FVs and the CVs. In other embodiments, sensors 114 may measure other variables which can be used to calculate the values of the FVs and the CVs.

The CVs may include one or more variables that can be controlled by operating equipment 112 and contribute to a reward function J (e.g., an objective function, a cost function, a value function, etc.). In some embodiments, the CVs represent the outputs of plant 110 and are affected by the process represented by plant 110. The reward function J quantifies the performance of plant 110 as a function of the CVs (and in some cases other variables in addition to the CVs) and may define one or more objectives which controller 120 seeks to minimize or maximize. For example, the reward function J may quantify a total cost of operating equipment 112 (e.g., electricity cost, the cost of input materials, etc.), a total value of the outputs produced by equipment 112 (e.g., a value of one or more oil products), an energy consumption of plant 110, an error between the outputs of plant 110 and target values, or any other function which can be used to quantify the performance of plant 110. In some embodiments, the value of the reward function J at a given time t is based on the values of the CVs at that same time t (e.g., Jₜ=f(c_{1,t}) c_{2,t}, . . . , c_{n,t})), where n is the total number of CVs included in the reward function J and the variables c_{1,t}, c_{2,t}, . . . , c_{n,t} are the values of the CVs at time t. In other embodiments, the value of the reward function J may be based on the values of the CVs over a predetermined time period including multiple time steps t (e.g., j=Σ_{t′=t}^{t+k}f(c_{1,t′}, c_{2,t′}) . . . , c_{n,t′})), where k is the total number of time steps t included in the time period over which the reward function J is evaluated.

The FVs may include one or more variables that are not included in the reward function J but may be useful for obtaining predictions of the CVs. For example, the FVs may be part of a subsystem of plant 110 such that the FVs affect the CVs but are not affected by the CVs. Alternatively, one or more of the FVs may be included in the reward function J in some embodiments. For example, the reward function J may be a function of both the CVs and the FVs (e.g., Jₜ=f(f_{1,t}, f_{2,t}, . . . , f_{m,t}, c_{1,t}, c_{2,t}, . . . , c_{n,t}) where m is the total number of FVs included in the reward function J and f_{1,t}, f_{2,t}, . . . , f_{m,t} are the values of those FVs at time t. It is contemplated that the reward function J may include the FVs in some embodiments but may not include the FVs in other embodiments.

Both the values of the CVs and the values of the FVs may be affected by the control actions uₜ provided as inputs to plant 110. Further, the values of the CVs may be affected by the values of the FVs. However, the causal relationship between the FVs and the CVs may be unidirectional such that the values of the CVs do not affect the values of the FVs. The following equations define these functional and causal relationships mathematically:

$${c}_{t + 1} = C ( {c}_{t} , {f}_{t} , {u}_{t} )$$

$${f}_{t + 1} = F ( {f}_{t} , {u}_{t} )$$

where cₜ₊₁ denotes the values of the CVs at time t+1, cₜ denotes the values of the CVs at time t, fₜ denotes the values of the FVs at time t, uₜ denotes the values of the control actions (e.g., manipulated variables (MVs) such as control signals, operating commands, setpoints, control inputs, etc.) at time t, C is a function that represents how the CVs evolve over time as a function of inputs to the main process and F is a function that represents how FVs evolve over time as a function of inputs to the subprocess. In various embodiments, each of cₜ₊₁, fₜ₊₁, cₜ, fₜ, and uₜ may be scalar values (e.g., a value of only one CV, FV, or MV) or vectors containing a plurality of CV, FV, or MV values (e.g., a value for each CV, FV, or MV included in the applicable function). For example, uₜ may include a single setpoint for plant 110 (e.g., a setpoint for a single variable) or multiple different setpoints for plant 110 (e.g., a vector of setpoints including a setpoint for each of multiple different variables). Similarly, cₜ may include a single CV value or may be a vector of multiple CV values for multiple different CVs.

In some embodiments, the values of the CVs at time t+1 depend on the values of the FVs at time t+1 rather than the values of the FVs at time t as shown in the following equation:

$${c}_{t + 1} = C ( {c}_{t} , {f}_{t + 1} , {u}_{t} )$$

This scenario may occur, for example, when the time steps are long or the subprocesses represented by the functions F are fast such that the values of the FVs change from fₜ to fₜ₊₁ prior to being provided as inputs to the main process represented by the function C. In some embodiments, the values of the CVs and FVs are also affected by disturbance variables (DVs) shown in FIG. 1 as dₜ. The values of the DVs can be measured by sensors 114 and/or forecasted by controller 120 and provided as inputs to the functions used to calculate the values of the CVs and the FVs. For example, each of the functions above can be augmented to include an additional input variable dₜ to account for the DVs in some embodiments.

In some embodiments, the values of the CVs at time t+1 depend on the values of the CVs, FVs, MVs, and/or DVs during a window of time leading up to time t+1. For example, the function C can be defined as:

$${c}_{t + 1} = C ( {c}_{t - h} , {c}_{t - h + 1} , … , {c}_{t} , {f}_{t - h} , {f}_{t - h + 1} , … , {f}_{t} , {u}_{t - h} , {u}_{t - h + 1} , … , {u}_{t} )$$

where h is the number of additional time steps prior to time t included in the window of time, cₜ₋ₕ, cₜ₋ₕ₊₁, . . . , cₜ is a series of values of the CVs from time t−h to time t, fₜ₋ₕ, fₜ₋ₕ₊₁, . . . , fₜ is a series of values of the FVs from time t−h to time t, and uₜ₋ₕ, uₜ₋ₕ₊₁, . . . , uₜ is a series of values of the MVs from time t−h to time t. In some embodiments, the value of fₜ₊₁ (i.e., the values of the FVs at time t+1) can also be included in the function C in addition to the values of the FVs from time t−h to time t. In some embodiments, the values of the DVs from time t−h to time t can be included in the function C in addition to the values of the CVs, FVs, and MVs.

Similarly, the values of the FVs at time t+1 may depend on the values of the FVs, MVs, and/or DVs during a window of time leading up to time t+1. For example, the function F can be defined as:

$${f}_{t + 1} = F ( {f}_{t - h} , {f}_{t - h + 1} , … , {f}_{t} , {u}_{t - h} , {u}_{t - h + 1} , … , {u}_{t} )$$

where h is the number of additional time steps prior to time t included in the window of time, fₜ₋ₕ, fₜ₋ₕ₊₁, . . . , fₜ is a series of values of the FVs from time t−h to time t, and uₜ₋ₕ, uₜ₋ₕ₊₁, . . . , uₜ is a series of values of the MVs from time t−h to time t. In some embodiments, the values of the DVs from time t−h to time t can be included in the function F in addition to the values of the CVs, FVs, and MVs.

For ease of explanation, the functions C and F are described primarily throughout the present disclosure as using a single value of each CV, FV, and/or MV (e.g., at time t) to predict the next values of the CVs and FVs at time t+1. However, it is contemplated that the functions C and F, along with any models that use such functions (e.g., main process model 122 and subprocess model(s) 124), can use a time window of values of the CVs, FVs, and/or MVs included in the respective functions C and F for a window of time leading up to time t+1 in some embodiments. Accordingly, all such references to the functions C and F, the main process model 122, and the subprocess models 124 throughout the present disclosure should be understood as encompassing an embodiment in which a time window of values of the CVs, FVs, and/or MVs (i.e., whichever variables are provided as inputs to those functions) are used to predict the values of the CVs and/or FVs at time t+1 (i.e., whichever variables are provided as outputs of those functions). A time window of values of the DVs can also be used to predict the values of the CVs and/or FVs at time t+1 in some embodiments.

Notably, it is evident from the equations for cₜ₊₁ and fₜ₊₁ above that the values of the CVs are affected by the values of the FVs, but the values of the CVs do not affect the values of the FVs. For example, the FVs may be the inputs to a process unit (e.g., a distillation column), whereas the CVs may be the outputs of the process unit. As another example, the control actions uₜ may be the setpoints (SPs) provided as inputs to a low-level controller or process (e.g., a PID controller or subprocess of plant 110), whereas the FVs may be the process variables (PVs) and outputs (OP) of the PID controller or subprocess. The output of the PID controller can be expressed as

$$O P = Pe + I \int e d t + D \frac{d e}{dt}$$

where e is the error term (e.g., eₜ=PVₜ−SPₜ) and the parameters P, I, and D are the tunable parameters of the PID controller. In this case, learning the function F may be equivalent to learning the values of the PID parameters. The values of the CVs may be the final outputs of the process controlled by the PID controller which are affected by the values of the FVs but do not affect the values of the FVs. In other words, the causal relationship between the FVs and the CVs may be unidirectional with the FVs being upstream variables that affect the downstream CVs during operation of plant 110, whereas the values of the downstream CVs do not affect the values of the FVs.

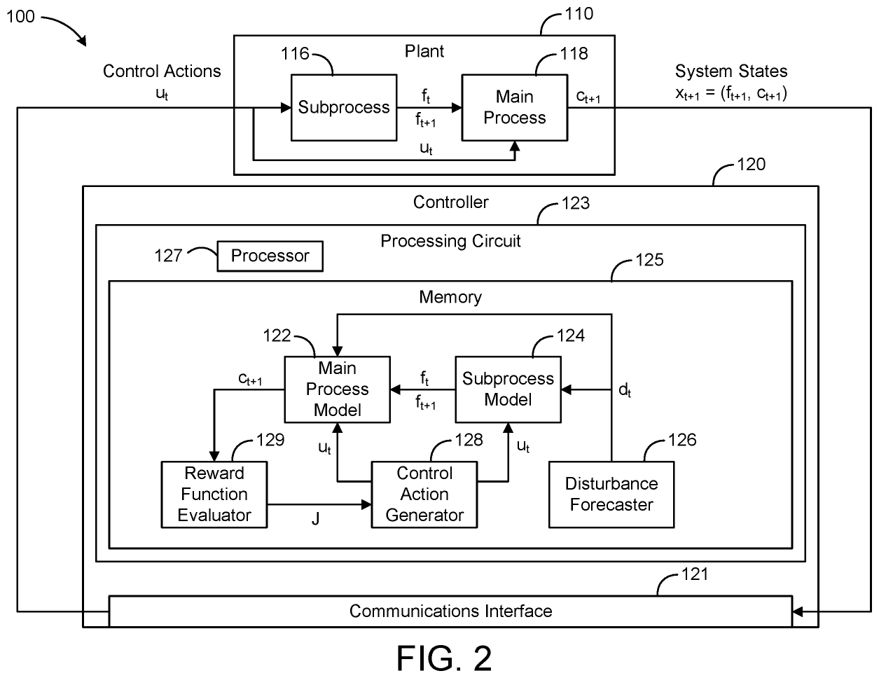

Still referring to FIG. 1, controller 120 is shown to include a main process model 122 and one or more subprocess models 124. Main process model 122 and subprocess models 124 may be arranged hierarchically (e.g., in series, upstream/downstream, etc.) such that the outputs of subprocess models 124 are provided as inputs to main process model 122. For example, subprocess models 124 may output predicted values of the FVs (i.e., values of fₜ) which are then provided as inputs to main process model 122. Various hierarchical arrangements of subprocess models 124 and main process model 122 are described in greater detail with reference to FIGS. 2-5C. During operation of controller 120 (either online or offline), main process model 122 may receive the predicted values of the FVs as inputs from subprocess models 124 and may output predicted values of the CVs. Main process model 122 can be represented by the equations cₜ₊₁=C(cₜ, fₜ, uₜ) or cₜ₊₁=C(cₜ, fₜ₊₁, uₜ), whereas subprocess models 124 can be represented by the equation fₜ₊₁=F(fₜ, uₜ) as previously described. In some embodiments, each of main process model 122 and subprocess models 124 can be augmented to include an additional input variable dₜ to account for the DVs. In some embodiments, main process model 122 can predict cₜ₊₁ at time t+1 as a function of a time window of values of the CVs, FVs, and MVs leading up to time t+1. Similarly, subprocess models 124 can predict fₜ₊₁ at time t+1 as a function of a time window of values of the FVs and MVs leading up to time t+1, as previously described. In various embodiments, main process model 122 and subprocess models 124 can be neural network models, parametric models, state-space models, or any other type of predictive models.

Controller 120 may receive the system states xₜ (and in some cases the disturbances dₜ) as feedback from plant 110 and may generate the control actions uₜ provided as input to plant 110. Controller 120 may use main process model 122 and subprocess models 124 to generate a set of control actions uₜ that optimize the reward function J. For example, controller 120 may use main process model 122 and subprocess models 124 to predict the values of the CVs and FVs that would result from a given trajectory of control actions uₜ over a given time period (e.g., a timeseries of the control actions uₜ for each time step within the time period) and may use the predicted values of the CVs to calculate the value of the reward function J. Controller 120 may adjust the set of control actions uₜ (e.g., using an iterative optimization process) until the value of the reward function J has been sufficiently optimized and may provide the resulting set of control actions uₜ as outputs. Plant 110 may receive the control actions uₜ from controller 120 and use the control actions uₜ to operate equipment 112.

Historical database 130 may store the values of the control actions uₜ, system states xₜ including fₜ and cₜ, disturbances dₜ, and/or any other variable of interest during online operation of plant 110 and controller 120. Historical database 130 may store a value for each of the MVs, CVs, DVs, FVs, and/or other variables of interest (e.g., values of the reward function J, values of variables measured by sensors 114, etc.) for each time step t. The values stored in historical database 130 for past time steps form a set of historical data which can be used to train main process model 122 and subprocess models 124.

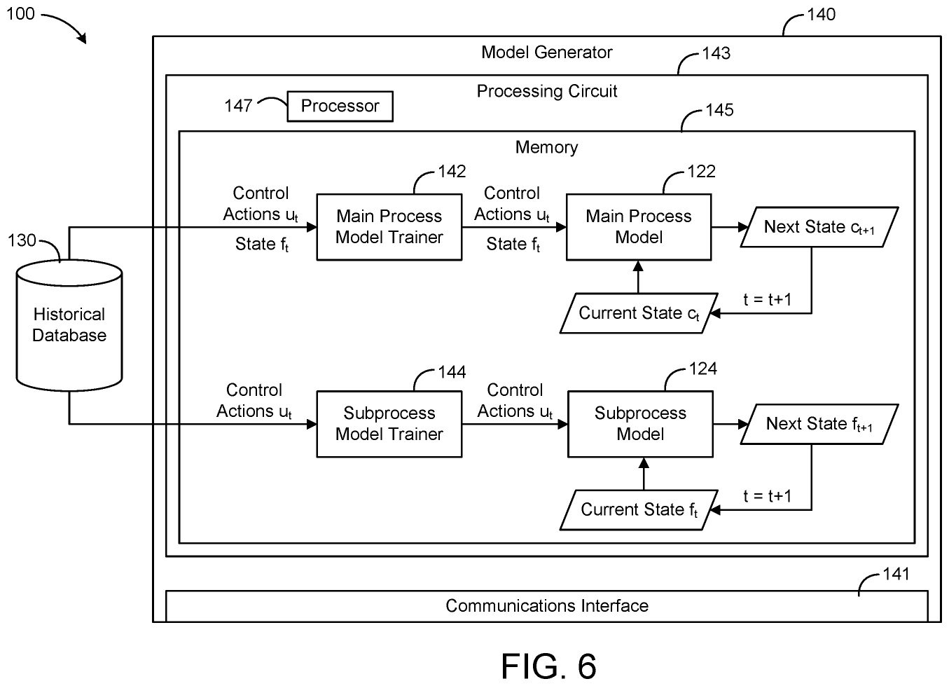

Model generator 140 may receive (e.g., obtain, gather, collect, etc.) the historical data from historical database 130 and may use the historical data to train main process model 122 and subprocess models 124. Model generator 140 is shown to include a main process model trainer 142 and one or more subprocess model trainers 144. Main process model trainer 142 can be configured to generate or train main process model 122. Similarly, subprocess model trainers 144 can be configured to generate or train subprocess models 124. The model training processes used by main process model trainer 142 and subprocess model trainers 144 are described in greater detail with reference to FIG. 6. In some embodiments, the model training processes performed by model generator 140 occur offline, separate from the online operation of controller 120. In other embodiments, model generator 140 may be integrated with or otherwise combined with controller 120 (e.g., model generator 140 may be a component of controller 120) and the functions performed by model generator 140 may be performed by controller 120. Once the model training processes are completed, model generator 140 can provide the trained main process model 122 and subprocess models 124 to controller 120 for use during online operation.

### Plant and Controller Hierarchical Models

Referring now to FIG. 2, a block diagram illustrating plant 110 and controller 120 in greater detail is shown, according to an exemplary embodiment. The embodiment shown in FIG. 2 illustrates a scenario in which plant 110 is represented as a single subprocess 116 and a main process 118. Subprocess 116 affects main process 118 but is not affected by main process 118. In various embodiments, subprocess 116 may include a physical subprocess of plant 110, a low-level controller of plant 110, or other subprocess which feeds into main process 118 during operation of plant 110. Subprocess 116 occurs upstream of main process 118 such that the outputs of subprocess 116 (e.g., fₜ₊₁) are provided as inputs to main process 118. The control actions uₜ generated by controller 120 are provided as inputs to both subprocess 116 and main process 118. Subprocess 116 operates according to the relationship fₜ₊₁=F(fₜ, uₜ) such that the control actions uₜ and the forecast variables fₜ at time t affect the values of the forecast variables fₜ₊₁ at time t+1. In some embodiments, subprocess 116 operates according to the relationship fₜ₊₁=F(fₜ₋ₕ, fₜ₋ₕ₊₁, . . . , fₜ, uₜ₋ₕ, uₜ₋ₕ₊₁, . . . , uₜ) such that the control actions uₜ₋ₕ, uₜ₋ₕ₊₁, . . . , uₜ and forecast variables fₜ₋ₕ, fₜ₋ₕ₊₁, . . . , fₜ during a window of time leading up to time t+1 affect the values of the forecast variables fₜ₊₁ at time t+1. The values of the forecast variables fₜ₊₁ at time t+1 are then provided as inputs to main process 118.

Main process 118 operates according to the relationship cₜ₊₁=C(cₜ, fₜ, uₜ) or cₜ₊₁=C(cₜ, fₜ₊₁, uₜ), such that the control actions uₜ at time t, the controlled variables cₜ at time t, and the forecast variables fₜ at time t or fₜ₊₁ at time t+1 affect the values of the controlled variables cₜ₊₁ at time t+1. In some embodiments, main process 118 operates according to the relationship cₜ₊₁=C(cₜ₋ₕ, cₜ₋ₕ₊₁, . . . , cₜ, fₜ₋ₕ, fₜ₋ₕ₊₁, . . . , fₜ, uₜ₋ₕ, uₜ₋ₕ₊₁, . . . , uₜ) such that the control actions uₜ₋ₕ, uₜ₋ₕ₊₁, . . . , uₜ, forecast variables fₜ₋ₕ, fₜ₋ₕ₊₁, . . . , fₜ (and optionally fₜ₊₁) and controlled variables cₜ₋ₕ, cₜ₋ₕ₊₁, . . . , cₜ during a window of time leading up to time t+1 affect the values of the controlled variables cₜ₊₁ at time t+1.

Controller 120 is shown to include communications interface 121 and processing circuit 123. Communications interface 121 can be or include wired or wireless communications interfaces (e.g., jacks, antennas, transmitters, receivers, transceivers, wire terminals, etc.) for conducting data communications. In various embodiments, communications via communications interface 121 can be direct (e.g., local wired or wireless communications) or via a communications network (e.g., a WAN, the Internet, a cellular network, etc.). For example, communications interface can include an Ethernet card and port for sending and receiving data via an Ethernet-based communications link or network. In another example, communications interface 121 can include a Wi-Fi transceiver for communicating via a wireless communications network. In another example, communications interface 121 can include cellular or mobile phone communications transceivers.

Processing circuit 123 is shown to include a processor 127 and memory 125. Processing circuit 123 can be communicably connected to communications interface 121 such that processing circuit 123 and the various components thereof can send and receive data via communications interface 121. Processor 127 can be implemented as a general-purpose processor, an application specific integrated circuit (ASIC), one or more field programmable gate arrays (FPGAs), a group of processing components, or other suitable electronic processing components.

Memory 125 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present disclosure. Memory 125 can be or include volatile memory or non-volatile memory. Memory 125 can include database components, object code components, script components, or any other type of information structure for supporting the various activities and information structures described in the present disclosure. According to an example embodiment, memory 125 is communicably connected to processor 127 via processing circuit 123 and includes computer code for executing (e.g., by processing circuit 123 and/or processor 127) one or more processes described herein.

In the embodiment shown in FIG. 2, controller 120 is shown to include main process model 122 and subprocess model 124, which function as described with reference to FIG. 1. Although only one main process model 122 and subprocess model 124 are shown in FIG. 2 and the description of FIG. 2 refers to such models in the singular (i.e., “model” rather than “models”) for ease of explanation, it should be understood that any number of main process models 122 and subprocess models 124 can be included in various alternative embodiments. The description of main process model 122 provided herein should be understood as referring to one or more main process models 122. Similarly, the description of subprocess model 124 provided herein should be understood as referring to one or more subprocess models 124.

Subprocess model 124 can be configured to predict the values of the FVs (e.g., fₜ) as a function of the MVs (e.g., the control actions uₜ) and the DVs (e.g., dₜ). In some embodiments, subprocess model 124 can be expressed as fₜ₊₁=F(fₜ, uₜ) such that the control actions uₜ and the forecast variables fₜ at time t affect the predicted values of the forecast variables fₜ₊₁ at time t+1. During online operation of controller 120, the predicted values of the forecast variables fₜ at time t and/or the predicted values of the forecast variables fₜ₊₁ at time t+1 are provided as inputs to main process model 122. Main process model 122 can be expressed as cₜ₊₁=C(cₜ, fₜ, uₜ) or cₜ₊₁=C(cₜ, fₜ₊₁, uₜ), such that the control actions uₜ at time t, the controlled variables cₜ at time t, and the predicted values of the forecast variables fₜ at time t or fₜ₊₁ at time t+1 affect the predicted values of the controlled variables cₜ₊₁ at time t+1. In some embodiments, main process model 122 can predict cₜ₊₁ at time t+1 as a function of a time window of values of the CVs, FVs, and MVs leading up to time t+1, whereas subprocess model 124 can predict fₜ₊₁ at time t+1 as a function of a time window of values of the FVs and MVs leading up to time t+1, as previously described.

Controller 120 is shown to include a disturbance forecaster 126. In some embodiments, each of main process model 122 and subprocess model 124 can be augmented to include an additional input variable dₜ to account for the DVs. Disturbance forecaster 126 can be configured to predict or forecast values of the DVs over a future time period for use in main process model 122 and subprocess model 124. In some embodiments, one or more of the DVs represents a measurable disturbance (e.g., outside air temperature, input oil quality, etc.) which can be measured by sensors 114 and provided to controller 120 as an input from plant 110. Other DVs may represent unmeasurable disturbances which cannot be directly observed by sensors 114 but can be predicted by disturbance forecaster 126. Disturbance forecaster 126 can use any of a variety of predictive models to predict values of the DVs for each time step and provides the values of the DVs as inputs to main process model 122 and subprocess model 124.

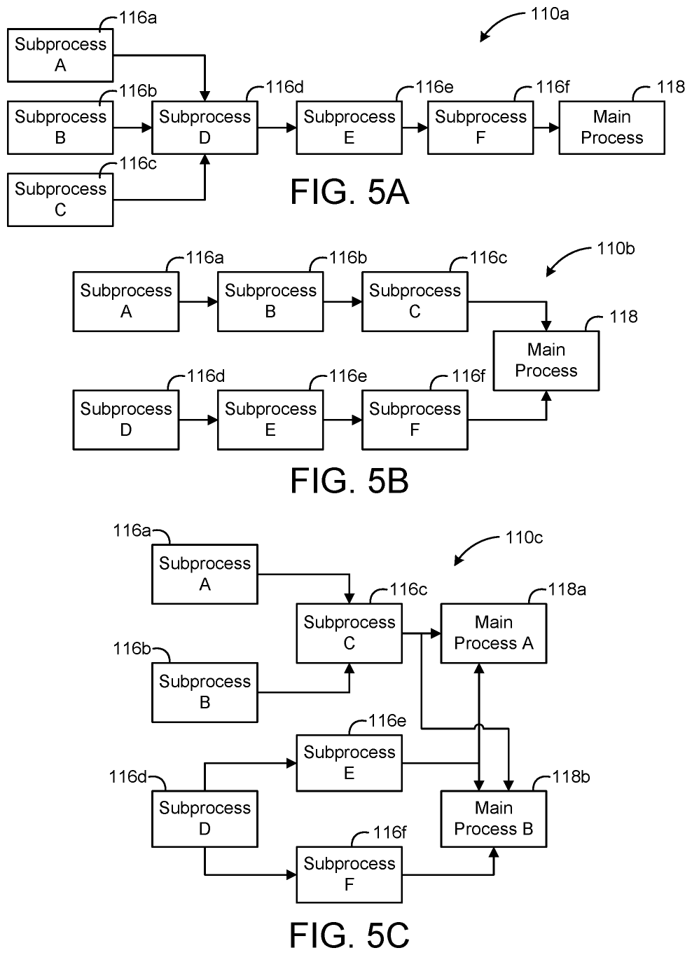

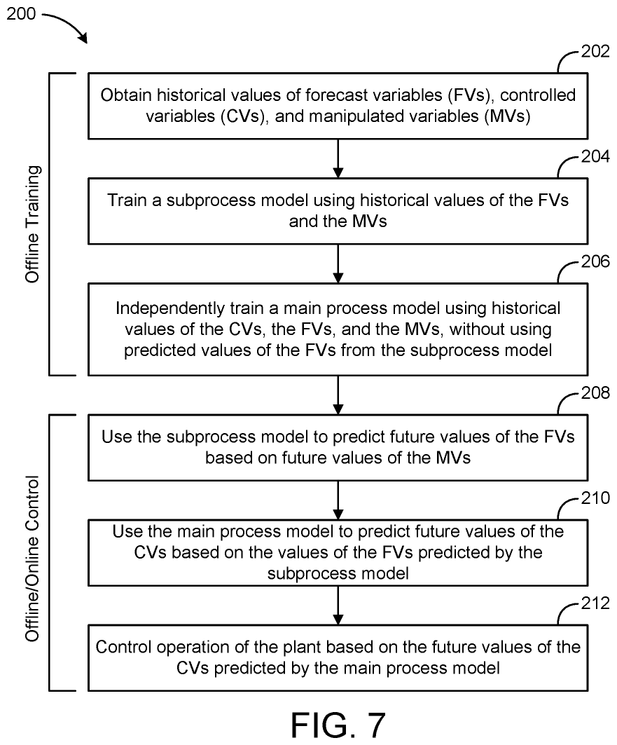

For control schemes in which main process model 122 and/or subprocess model 124 are used for online control, disturbance forecaster 126 can be used to predict future disturbances that affect subprocess 116 and/or main process 118 during online operation of controller 120. One example of such a control scheme is the model predictive control (MPC) scheme described in U.S. patent application Ser. No. 17/831,227 filed Jun. 2, 2022 (“the '227 application”), the entire disclosure of which is incorporated by reference herein. See FIGS. 5-6 of the '227 application and the description thereof for a detailed example of a MPC scheme which can be used by controller 120 in some embodiments. However, it should be understood that controller 120 can use any of a variety of control schemes in various other embodiments. For example, controller 120 can use a neural network control scheme such as any of the neural network embodiments described in the '227 application. See FIGS. 7-20 of the '227 application and the description thereof for detailed examples of various neural network control schemes which can be used by controller 120. Some of the neural network control schemes which can be used by controller 120 can generally be referred to as deep learning process control (DLPC) schemes. Some DLPC schemes may use a predictor online such as the MPC scheme discussed above, whereas other DLPC schemes may use a predictor offline for training a controller neural network. For embodiments in which controller 120 uses a predictor offline to train a controller neural network, the training of the controller neural network may be performed using historical data where the disturbance values are known. Accordingly, the trained controller neural network in a DLPC scheme may have learned to account for future disturbance changes and thus may effectively include a disturbance forecaster within, rather than relying on predictions from a separate disturbance forecaster 126 as shown in FIG. 2. It should be understood that controller 120 can use a control scheme with an online predictor, a control scheme with an offline predictor, or any other control scheme in various embodiments and that all such embodiments are within the scope of the present disclosure.

Controller 120 is shown to include a reward function evaluator 129. Reward function evaluator 129 may receive the values of the CVs predicted by main process model 122 and may use the predicted values of the CVs to evaluate the reward function J. As described with reference to FIG. 1, the reward function J quantifies the performance of plant 110 as a function of the CVs (and in some cases other variables in addition to the CVs) and may define one or more objectives which controller 120 seeks to minimize or maximize. Reward function evaluator 129 can use the values of the CVs at one or more time steps to evaluate the reward function J. In some embodiments, the value of the reward function J at a given time t is based on the values of the CVs at that same time t (e.g., Jₜ=f(c_{1,t}, c_{2,t}, . . . , c_{n,t}), where n is the total number of CVs included in the reward function J and the variables c_{1,t}, c_{2,t}, . . . , c_{n,t} are the values of the CVs at time t. In other embodiments, the value of the reward function J may be based on the values of the CVs over a predetermined time period including multiple time steps t (e.g., J=Σ_{t′=t}^{t+k}f(c_{1,t′}, c_{2,t′}, . . . , c_{n,t′}), where k is the total number of time steps t included in the time period over which the reward function J is evaluated. In some embodiments, the values of one or more of the FVs, MVs, and/or DVs at one or more time steps can be included in the reward function J in addition to the values of the CVs, as previously described. Reward function evaluator 129 may obtain values of the CVs, FVs, MVs, and/or DVs for each time step in the reward function J and use the values of the CVs, FVs, MVs, and/or DVs to calculate the value of the reward function J.

Controller 120 is shown to further include a control action generator 128. Control action generator 128 can be configured to generate a set of control actions uₜ to be provided as inputs to plant 110. Control action generator 128 may use main process model 122 and subprocess models 124 to generate a set of control actions uₜ that optimize the reward function J. For example, control action generator 128 may use main process model 122 and subprocess models 124 to predict the values of the CVs and FVs that would result from a given trajectory of control actions uₜ over a given time period (e.g., a timeseries of the control actions uₜ for each time step within the time period). Control action generator 128 may use reward function evaluator 129 to calculate the value of the reward function J based on the predicted values of the CVs and/or FVs. Control action generator 128 may adjust the set of control actions uₜ (e.g., using an iterative optimization process) until the value of the reward function J has been sufficiently optimized and may provide the resulting set of control actions uₜ as outputs to plant 110.

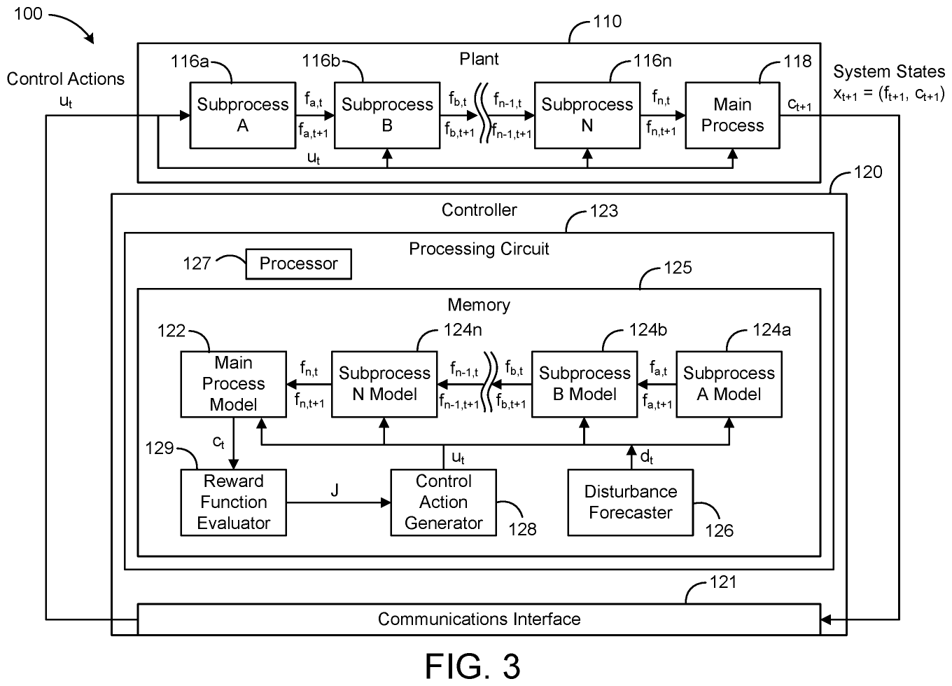

Referring now to FIG. 3, a block diagram illustrating plant 110 and controller 120 in greater detail is shown, according to another exemplary embodiment. The embodiment shown in FIG. 3 illustrates a scenario in which plant 110 is represented as a series of subprocesses 116a, 116b, . . . , 116n (collectively subprocesses 116), where N is the total number of subprocesses 116, and a main process 118 downstream of the subprocesses 116. Subprocesses 116 are arranged in series with each other such that the outputs of subprocess A 116a are provided as inputs to subprocess B 116b. Similarly, the outputs of subprocess B 116b are provided as inputs to the next sequential subprocess 116. This continues until the final subprocess N 116n which receives the outputs from the penultimate subprocess N−1 (not shown) and generates the final subprocess output. The outputs of subprocess N 116n are provided as inputs to main process 118. The control actions uₜ generated by controller 120 are provided as inputs to each of subprocesses 116 and main process 118.

In some embodiments, each of subprocesses 116 operates according to the relationship fₜ₊₁=F(fₜ, uₜ) such that the control actions uₜ and the forecast variables fₜ at time t affect the values of the forecast variables fₜ₊₁ at time t+1 output by the subprocess 116. For example, subprocess A 116a may operate according to the relationship f_{a,t+1}=Fₐ(f_{a,t}, uₜ) such that the control actions uₜ and the forecast variables fat at time t affect the values of the forecast variables f_{a,t+1} at time t+1 output by subprocess A 116a. The function Fₐ denotes the relationship or transformation represented by subprocess A 116a used to translate the inputs fat and uₜ into the outputs f_{a,t+1}. In some embodiments, the function Fₐ also receives as input prior values of the forecast variables fₐ and/or the control actions u during a time window prior to time t.

Similarly, subprocess B 116b may operate according to the relationship f_{b,t+1}=F_{b}(f_{b,t}, uₜ) such that the control actions uₜ and the forecast variables f_{b,t} at time t affect the values of the forecast variables f_{b,t+1} at time t+1 output by subprocess B 116b. The function F_{b} denotes the relationship or transformation represented by subprocess B 116b used to translate the inputs f_{b,t} and uₜ into the outputs f_{b,t+1}. In some embodiments, the function F_{b} representing subprocess B 116b is also a function of the outputs of subprocess A 116a. For example, the function F_{b} can be expressed as f_{b,t+1}=F_{b}(f_{b,t}, uₜ, f_{a,t}) or f_{b,t+1}=F_{b}(f_{b,t}, uₜ, f_{a,t+1}) such that the outputs of subprocess A 116a for time t (i.e., f_{a,t}) or time t+1 (i.e., f_{a,t+1}) are an additional input to the function F_{b}. Accordingly, the function F_{b} may represent the relationship or transformation represented by subprocess B 116b used to translate the inputs f_{b,t}, uₜ, and f_{a,t} or f_{a,t+1} into the outputs f_{b,t+1}. In some embodiments, the function F_{b} also receives as input prior values of the forecast variables fₐ, f_{b,t}, and/or the control actions u during a time window prior to time t.

The sequential operation of subprocesses 116 continues until subprocess N 116n which receives the outputs of the penultimate subprocess N−1 (e.g., f_{n-1,t} or f_{n-1,t+1}). Subprocess N 116n may operate according to the relationship f_{n,t+1}=Fₙ(f_{n,t}, uₜ) such that the control actions uₜ and the forecast variables f_{n,t} at time t affect the values of the forecast variables f_{n,t+1} at time t+1 output by subprocess N 116n. The function Fₙ denotes the relationship or transformation represented by subprocess N 116n used to translate the inputs f_{n,t} and uₜ into the outputs f_{n,t+1}. In some embodiments, the function Fₙ representing subprocess N 116n is also a function of the outputs of subprocess N−1. For example, the function Fₙ can be expressed as f_{n,t+1}=Fₙ(f_{n,t}, uₜ, f_{n-1,t}) or f_{n,t+1}=Fₙ(f_{n,t}, uₜ, f_{n-1,t+1}) such that the outputs of subprocess N−1 for time t (i.e., f_{n-1,t}) or time t+1 (i.e., f_{n-1,t+1}) are an additional input to the function Fₙ. Accordingly, the function Fₙ may represent the relationship or transformation represented by subprocess N 116n used to translate the inputs f_{n,t}, uₜ, and f_{n-1,t} or f_{n-1,t+1} into the outputs f_{n,t+1}. In some embodiments, the function Fₙ also receives as input prior values of the forecast variables fₙ₋₁, fₙ, and/or the control actions u during a time window prior to time t.

The values of the forecast variables f_{n,t} at time t or f_{n,t+1} at time t+1 generated by subprocess N 116n are then provided as inputs to main process 118. Main process 118 operates according to the relationship cₜ₊₁=C(cₜ, f_{n,t}, uₜ) or cₜ₊₁=C(cₜ, f_{n,t+1}, uₜ), such that the control actions uₜ at time t, the controlled variables cₜ at time t, and the forecast variables f_{n,t} at time t or f_{n,t+1} at time t+1 output by the final sequential subprocess N 116n affect the values of the controlled variables cₜ₊₁ at time t+1. In some embodiments, the function C also includes prior values of the controlled variables cₜ the forecast variables fₙ, and/or the control actions u during a time window prior to time t. In the embodiment of FIG. 3, main process 118 may be the same as or similar to the embodiment described with reference to FIG. 2, with the exception that main process 118 receives input from subprocess N 116n instead of the single subprocess 116 shown in FIG. 2.

Still referring to FIG. 3, controller 120 is shown to include many of the same components as the embodiment of FIG. 2 (e.g., communications interface 121, processing circuit 123, memory 125, disturbance forecaster 126, processor 127, control action generator 128, and reward function evaluator 129). These components may perform the same or similar functions as described with reference to FIG. 2. However, instead of the single subprocess model 124 shown in FIG. 2, controller 120 is shown to include a series of subprocess models 124a, 124b, . . . , 124n (collectively subprocess models 124), where N is the total number of subprocess models 124. Each of subprocess models 124 may correspond to one of the subprocesses 116 and can be used to predict the outputs of the corresponding subprocess 116. For example, subprocess A model 124a may correspond to subprocess A 116a, subprocess B model 124b may correspond to subprocess B 116b, etc. Subprocess models 124 may be arranged in series with each other and with main process model 122 to match the series arrangement of the corresponding subprocesses 116 in plant 110.

Each of subprocess models 124 can be configured to predict the outputs of the corresponding subprocess 116 in plant 110. For example, subprocess A model 124a may be configured to predict the outputs of subprocess A 116a. In some embodiments, subprocess A model 124a can be expressed as f_{a,t+1}=Fₐ(f_{a,t}, uₜ) such that the control actions uₜ and the forecast variables fat at time t affect the predicted values of the forecast variables f_{a,t+1} at time t+1 output by subprocess A model 124a. The function Fₐ denotes the relationship or transformation used by subprocess A model 124a to translate the inputs f_{a,t} and uₜ into the outputs f_{a,t+1}. In some embodiments, subprocess A model 124a can be augmented to include an additional input variable dₜ to account for DVs, as described above. In some embodiments, the function Fₐ also includes prior values of the forecast variables fₐ, the disturbance variables d, and/or the control actions u during a time window prior to time t.

Similarly, subprocess B model 124b may be configured to predict the outputs of subprocess B 116b. In some embodiments, subprocess B model 124b can be expressed as f_{b,t+1}=F_{b}(f_{b,t}, uₜ) such that the control actions uₜ and the forecast variables f_{b,t} at time t affect the predicted values of the forecast variables f_{b,t+1} at time t+1 output by subprocess B model 124b. The function F_{b} denotes the relationship or transformation used by subprocess B model 124b to translate the inputs f_{b,t} and uₜ into the outputs f_{b,t+1}. In some embodiments, subprocess B model 124b is also a function of the outputs of subprocess A 116a. For example, the function F_{b} can be expressed as f_{b,t+1}=F_{b}(f_{b,t}, uₜ, f_{a,t}) or f_{b,t+1}=F_{b}(f_{b,t}, uₜ, f_{a,t+1}) such that the outputs of subprocess A 116a for time t (i.e., f_{a,t}) or time t+1 (i.e., f_{a,t+1}) are an additional input to the function F_{b}. Accordingly, the function F_{b} may represent the relationship or transformation represented by subprocess B model 124b used to translate the inputs f_{b,t}, uₜ, and f_{a,t} or f_{a,t+1} into the outputs f_{b,t+1}. In some embodiments, subprocess B model 124b can be augmented to include an additional input variable dₜ to account for DVs, as described above. In some embodiments, the function F_{b} also receives as input prior values of the forecast variables fₐ, f_{b}, the disturbance variables d, and/or the control actions u during a time window prior to time t.

Controller 120 can use each sequential subprocess model 124 to predict the outputs of the corresponding subprocess 116 until reaching the final subprocess model 124n. Subprocess N model 124n receives the outputs of the penultimate subprocess model for subprocess N−1 (e.g., f_{n-1,t} or f_{n-1,t+1}). Subprocess N model 124n can be expressed as f_{n,t+1}=Fₙ(f_{n,t}, uₜ) such that the control actions uₜ and the forecast variables f_{n,t} at time t affect the predicted values of the forecast variables f_{n,t+1} at time t+1 output by subprocess N model 124n. The function Fₙ denotes the relationship or transformation used by subprocess N model 124n to translate the inputs f_{n,t} and uₜ into the outputs f_{n,t+1}. In some embodiments, the function Fₙ used by subprocess N model 124n is also a function of the outputs of the subprocess model for subprocess N−1. For example, the function Fₙ can be expressed as f_{n,t+1}=Fₙ(f_{n,t}, uₜ, f_{n-1,t}) or f_{n,t+1}=Fₙ(f_{n,t}, uₜ, f_{n-1,t+1}) such that the outputs of the subprocess N−1 model for time t (i.e., f_{n-1,t}) or time t+1 (i.e., f_{n-1,t+1}) are an additional input to the function Fₙ in subprocess N model 124n. Accordingly, the function Fₙ may represent the relationship or transformation used by subprocess N model 124n to translate the inputs f_{n,t}, uₜ, and f_{n-1,t} or f_{n-1,t+1} into the outputs f_{n,t+1}. In some embodiments, subprocess N model 124n can be augmented to include an additional input variable dₜ to account for DVs, as described above. In some embodiments, the function Fₙ also receives as input prior values of the forecast variables fₙ₋₁, fₙ, the disturbance variables d, and/or the control actions u during a time window prior to time t.

The predicted values of the forecast variables f_{n,t} at time t or f_{n,t+1} at time t+1 generated by subprocess N model 124n are then provided as inputs to main process model 122. Main process model 122 can predict the values of the CVs output by main process 118 according to the relationship cₜ₊₁=C(cₜ, f_{n,t}, uₜ) or cₜ₊₁=C(cₜ, f_{n,t+1}, uₜ), such that the control actions uₜ at time t, the controlled variables cₜ at time t, and the forecast variables f_{n,t} at time t or f_{n,t+1} at time t+1 output by the final subprocess model 124n affect the predicted values of the controlled variables cₜ₊₁ at time t+1. In some embodiments, main process model 122 can be augmented to include an additional input variable dₜ to account for DVs, as described above. In some embodiments, the function C also includes prior values of the controlled variables c, the forecast variables fₙ, the disturbance variables d, and/or the control actions u during a time window prior to time t. In the embodiment of FIG. 3, main process model 122 may be the same as or similar to the embodiment described with reference to FIG. 2, with the exception that main process model 122 receives input from subprocess N model 124n instead of the single subprocess model 124 shown in FIG. 2.

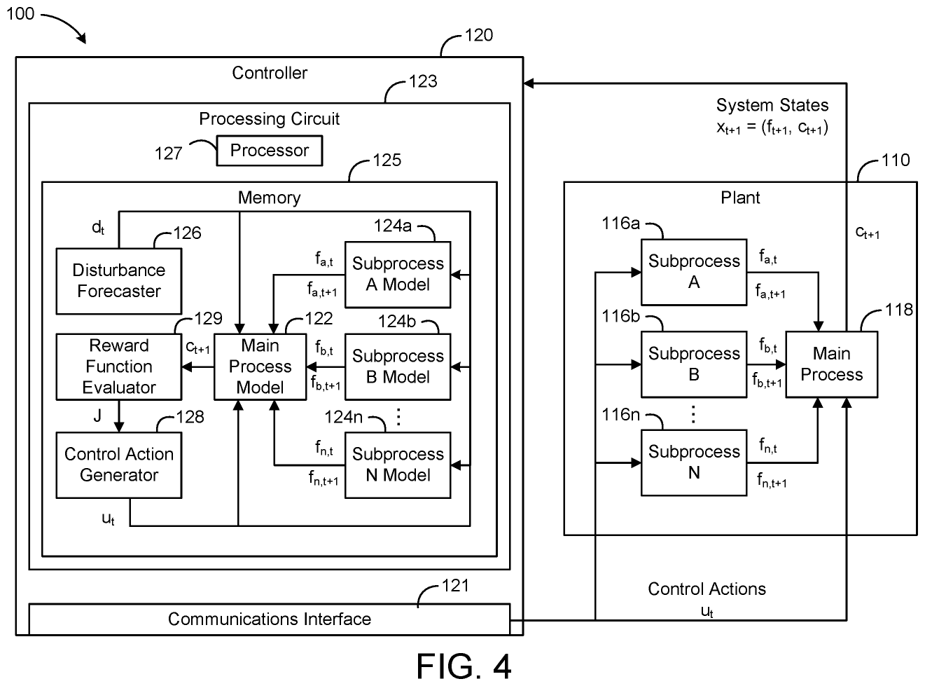

Referring now to FIG. 4, a block diagram illustrating plant 110 and controller 120 in greater detail is shown, according to another exemplary embodiment. The embodiment shown in FIG. 4 illustrates a scenario in which plant 110 is represented as a set of parallel subprocesses 116a, 116b, . . . , 116n (collectively subprocesses 116), where N is the total number of subprocesses 116, and a main process 118 downstream of the subprocesses 116. Subprocesses 116 are arranged in parallel with each other and in series with main process 118 such that the outputs of each of subprocesses 116 are provided as inputs to main process 118. The control actions uₜ generated by controller 120 are provided as inputs to each of subprocesses 116 and main process 118.

In some embodiments, each of subprocesses 116 operates according to the relationship fₜ₊₁=F(fₜ, uₜ) such that the control actions uₜ and the forecast variables fₜ at time t affect the values of the forecast variables fₜ₊₁ at time t+1 output by the subprocess 116. For example, subprocess A 116a may operate according to the relationship f_{a,t+1}=Fₐ(f_{a,t}, uₜ) such that the control actions uₜ and the forecast variables fat at time t affect the values of the forecast variables f_{a,t+1} at time t+1 output by subprocess A 116a. In some embodiments, subprocess A 116a is also affected by disturbances dₜ which can be received as another input in the function Fₐ, as described above. The function Fₐ denotes the relationship or transformation represented by subprocess A 116a used to translate the inputs f_{a,t}, uₜ, and/or dₜ into the outputs f_{a,t+1}. In some embodiments, the function Fₐ also receives as input prior values of the forecast variables fₐ, disturbance variables d, and/or the control actions u during a time window prior to time t.

Similarly, subprocess B 116b may operate according to the relationship f_{b,t+1}=F_{b}(f_{b,t}, uₜ) such that the control actions uₜ and the forecast variables f_{b,t} at time t affect the values of the forecast variables f_{b,t+1} at time t+1 output by subprocess B 116b. In some embodiments, subprocess B 116b is also affected by disturbances dₜ which can be received as another input in the function F_{b}, as described above. The function F_{b} denotes the relationship or transformation represented by subprocess B 116b used to translate the inputs f_{b,t}, uₜ, and/or dₜ into the outputs f_{b,t+1}. In some embodiments, the function F_{b} also receives as input prior values of the forecast variables f_{b,t}, disturbance variables d, and/or the control actions u during a time window prior to time t.

Unlike the embodiment of FIG. 3 in which the second through Nth subprocesses 116b-116n were dependent upon previous subprocesses in the series, the parallel arrangement of FIG. 4 can be used to represent a scenario in which subprocesses 116 operate independently from one another such that the output of each subprocess 116 does not depend on any other subprocess 116. However, the set of parallel subprocesses 116 are still arranged in series with main process 118 such that the outputs of each of subprocesses 116 are provided as inputs to main process 118. For example, the values of the forecast variables f_{a,t}, f_{b,t}, . . . , f_{n,t} at time t and/or f_{a,t+1}, f_{b,t+1}, . . . , f_{n,t+1} at time t+1 generated by subprocesses 116a-116n can be provided as inputs to main process 118.

Main process 118 operates according to the relationship cₜ₊₁=C(cₜ, f_{a,t}, f_{b,t}, . . . f_{n,t}, uₜ) or cₜ₊₁=C(cₜ, f_{a,t+1}, f_{b,t+1}, . . . , f_{n,t+1}, uₜ), such that the control actions uₜ at time t, the controlled variables cₜ at time t, and the forecast variables f_{a,t}, f_{b,t}, . . . , f_{n,t} at time t and/or f_{a,t+1}, f_{b,t+1}, . . . , f_{n,t+1} at time t+1 output by subprocesses 116 affect the values of the controlled variables cₜ₊₁ at time t+1. In some embodiments, main process 118 is also affected by disturbances dₜ which can be received as another input in the function C, as described above. In some embodiments, the function C also includes prior values of the controlled variables c, the forecast variables fₐ, f_{b}, . . . , fₙ, the disturbance variables d, and/or the control actions u during a time window prior to time t. In the embodiment of FIG. 4, main process 118 may be the same as or similar to the embodiments described with reference to FIGS. 2 and 3, with the exception that main process 118 receives input from all of subprocesses 116a-116n in parallel instead of the single subprocess 116 shown in FIG. 2 or the final sequential subprocess 116n shown in FIG. 3.

Still referring to FIG. 4, controller 120 is shown to include many of the same components as the embodiments of FIGS. 2-3 (e.g., communications interface 121, processing circuit 123, memory 125, disturbance forecaster 126, processor 127, control action generator 128, and reward function evaluator 129). These components may perform the same or similar functions as described with reference to FIGS. 2-3. However, instead of the single subprocess model 124 shown in FIG. 2 or the series of sequential subprocess models 124 shown in FIG. 3, controller 120 is shown to include a set of parallel subprocess models 124a, 124b, . . . , 124n (collectively subprocess models 124), where N is the total number of subprocess models 124. Each of subprocess models 124 may correspond to one of the subprocesses 116 and can be used to predict the outputs of the corresponding subprocess 116. For example, subprocess A model 124a may correspond to subprocess A 116a, subprocess B model 124b may correspond to subprocess B 116b, etc. Subprocess models 124 may be arranged in parallel with each other and in series with main process model 122 to match the arrangement of the corresponding subprocesses 116 in plant 110.

Each of subprocess models 124 can be configured to predict the outputs of the corresponding subprocess 116 in plant 110. For example, subprocess A model 124a may be configured to predict the outputs of subprocess A 116a. In some embodiments, subprocess A model 124a can be expressed as f_{a,t+1}=Fₐ(f_{a,t}, uₜ) such that the control actions uₜ and the forecast variables fat at time t affect the predicted values of the forecast variables f_{a,t+1} at time t+1 output by subprocess A model 124a. In some embodiments, subprocess A model 124a also receives disturbance variables dₜ as an input to the function Fₐ, as described above. The function Fₐ denotes the relationship or transformation used by subprocess A model 124a to translate the inputs f_{a,t}, uₜ, and/or dₜ into the outputs f_{a,t+1}. In some embodiments, the function Fₐ also receives as input prior values of the forecast variables fₐ, disturbance variables d, and/or the control actions u during a time window prior to time t.

Similarly, subprocess B model 124b may be configured to predict the outputs of subprocess B 116b. In some embodiments, subprocess B model 124b can be expressed as f_{b,t+1}=F_{b}(f_{b,t}, uₜ) such that the control actions uₜ and the forecast variables f_{b,t} at time t affect the predicted values of the forecast variables f_{b,t+1} at time t+1 output by subprocess B model 124b. In some embodiments, subprocess B model 124b also receives disturbance variables dₜ as an input to the function F_{b}, as described above. The function F_{b} denotes the relationship or transformation used by subprocess B model 124b to translate the inputs f_{b,t}, uₜ, and/or dₜ into the outputs f_{b,t+1}. In some embodiments, the function F_{b} also receives as input prior values of the forecast variables f_{b,t}, disturbance variables d, and/or the control actions u during a time window prior to time t.

Controller 120 can use each parallel subprocess model 124 to predict the outputs of the corresponding subprocess 116. Controller 120 can provide the outputs of subprocess models 124 as parallel inputs to main process model 122. For example, the predicted values of the forecast variables f_{a,t}, f_{b,t}, . . . , f_{n,t} at time t and/or f_{a,t+1}, f_{b,t+1}, . . . , f_{n,t+1} at time t+1 generated by subprocess models 124a-124n can all be provided as inputs to main process model 122. Main process model 122 can be expressed as cₜ₊₁=C(cₜ, f_{a,t}, f_{b,t}, . . . , f_{n,t}, uₜ) or cₜ₊₁=C(cₜ) f_{a,t+1}, f_{b,t+1}, . . . , f_{n,t+1}, uₜ), such that the control actions uₜ at time t, the controlled variables cₜ at time t, and the forecast variables f_{a,t}, f_{b,t}, . . . , f_{n,t} at time t and/or f_{a,t+1}, f_{b,t+1}, . . . , f_{n,t+1} at time t+1 output by subprocess models 124 affect the predicted values of the controlled variables cₜ₊₁ at time t+1. In some embodiments, main process model 122 also receives disturbance variables dₜ as an input to the function C, as described above. In some embodiments, the function C also includes prior values of the controlled variables c, the forecast variables fₐ, f_{b}, . . . , fₙ, the disturbance variables d, and/or the control actions u during a time window prior to time t. In the embodiment of FIG. 4, main process model 122 may be the same as or similar to the embodiments described with reference to FIGS. 2 and 3, with the exception that main process model 122 receives input from all of subprocess models 124a-124n in parallel instead of the single subprocess model 124 shown in FIG. 2 or the final sequential subprocess model 124n shown in FIG. 3.

In various embodiments, plant 110 can include any arrangement of main process 118 and subprocesses 116 including the single subprocess 116 and main process 118 shown in FIG. 2, the series arrangement shown in FIG. 3, the parallel arrangement shown in FIG. 4, or any combination thereof. Additionally, it is contemplated that plant 110 may include multiple main processes 118, each of which may be arranged downstream one or more of subprocesses 116. The various subprocesses 116 and main processes 118 of plant 110 may have any arrangement with respect to each other (e.g., parallel, series, parallel/series combinations, etc.) and may be independent or interdependent in various embodiments. Several examples of potential arrangements of subprocesses 116 and main processes 118 in plant 110 are shown in FIGS. 5A-5C. However, it is contemplated that the arrangement of subprocesses 116 and main processes 118 can be adapted to match any arrangement of equipment in plant 110 and the various examples described herein should be understood as illustrating only a few of the possible arrangements of subprocesses 116 and main processes 118 within the scope of the present disclosure.

Referring now to FIG. 5A, another potential arrangement of subprocesses 116 with a single main process 118 is shown as plant 110a (i.e., an embodiment of plant 110). As shown in FIG. 5A, plant 110a may include a first set of subprocesses 116a-116c arranged in parallel with each other. The parallel set of subprocesses 116a-116c may be arranged in series with a second set of subprocesses 116d-116f. The outputs of each of subprocesses 116a-116c are provided as inputs to subprocess 116d in parallel. The output of subprocess 116d is then provided as an input to a next sequential subprocess 116e and the output of subprocess 116e is provided as an input to the final sequential subprocess 116f. The output of subprocess 116f is then provided as an input to main process 118. To model and control plant 110a, the arrangement of subprocess models 124 and main process model 122 in controller 120 can be adapted to match the arrangement of subprocesses 116 and main process 118 shown in FIG. 5A.

Referring now to FIG. 5B, another potential arrangement of subprocesses 116 with a single main process 118 is shown as plant 110b (i.e., another embodiment of plant 110). As shown in FIG. 5B, plant 110b may include a first set of subprocesses 116a-116c arranged in series with each other such that the output of subprocess 116a is provided as an input to subprocess 116b and the output of subprocess 116b is provided as an input to subprocess 116c. The entire first set of subprocesses 116a-116c is arranged in parallel with a second set of subprocesses 116d-116f. Subprocesses 116d-116f are arranged in series with each other such that the output of subprocess 116d is provided as an input to subprocess 116e and the output of subprocess 116e is provided as an input to subprocess 116f. The outputs of each of subprocesses 116c and 116f are then provided as inputs to main process 118 in parallel. To model and control plant 110b, the arrangement of subprocess models 124 and main process model 122 in controller 120 can be adapted to match the arrangement of subprocesses 116 and main process 118 shown in FIG. 5B.

Referring now to FIG. 5C, another potential arrangement of subprocesses 116 with multiple main processes 118 is shown as plant 110c (i.e., another embodiment of plant 110). As shown in FIG. 5C, subprocess 116a and subprocess 116b are arranged in parallel with each other such that the outputs of both subprocesses 116a-116b are provided as inputs to subprocess 116c. The output of subprocess 116c is provided as an input to both main process 118a and main process 118b. Another branch of plant 110c includes subprocesses 116d-116f. The output of subprocess 116d is provided as input to both subprocesses 116e and 116f. The output of subprocess 116e is provided as inputs to both main process 118a and main process 118b. The output of subprocess 116f is provided as an input to only main process 118b. To model and control plant 110c, the arrangement of subprocess models 124 and main process models 122 in controller 120 can be adapted to match the arrangement of subprocesses 116 and main processes 118 shown in FIG. 5C.

Although only a few potential arrangements of subprocesses 116 and main processes 118 are described in detail, it is contemplated that any arrangement could be used to represent varying arrangements of equipment 112 in plant 110. Each subprocess 116 or set of parallel/series subprocesses 116 can be arranged upstream of one or more main processes 118 and may provide values of forecast variables as input to the downstream main process(es) 118. Similarly, the arrangement of main process model(s) 122 and subprocess model(s) 124 in controller 120 can be adapted to match any arrangement of parallel, series, or other arrangement of main process(es) 118 and subprocess(es) 116 in plant 110. All such arrangements of subprocesses, main processes 118, subprocess models 124, and main process models 122 are within the scope of the present disclosure.

### Model Generation

Referring now to FIG. 6, a block diagram illustrating model generator 140 in greater detail is shown, according to an exemplary embodiment. Model generator 140 is shown to include communications interface 141 and processing circuit 143. Communications interface 141 can be or include wired or wireless communications interfaces (e.g., jacks, antennas, transmitters, receivers, transceivers, wire terminals, etc.) for conducting data communications. In various embodiments, communications via communications interface 141 can be direct (e.g., local wired or wireless communications) or via a communications network (e.g., a WAN, the Internet, a cellular network, etc.). For example, communications interface can include an Ethernet card and port for sending and receiving data via an Ethernet-based communications link or network. In another example, communications interface 141 can include a Wi-Fi transceiver for communicating via a wireless communications network. In another example, communications interface 141 can include cellular or mobile phone communications transceivers.

Processing circuit 143 is shown to include a processor 147 and memory 145. Processing circuit 143 can be communicably connected to communications interface 141 such that processing circuit 143 and the various components thereof can send and receive data via communications interface 141. Processor 147 can be implemented as a general-purpose processor, an application specific integrated circuit (ASIC), one or more field programmable gate arrays (FPGAs), a group of processing components, or other suitable electronic processing components.

Memory 145 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present disclosure. Memory 145 can be or include volatile memory or non-volatile memory. Memory 145 can include database components, object code components, script components, or any other type of information structure for supporting the various activities and information structures described in the present disclosure. According to an example embodiment, memory 145 is communicably connected to processor 147 via processing circuit 143 and includes computer code for executing (e.g., by processing circuit 143 and/or processor 147) one or more processes described herein.

Model generator 140 is shown to include main process model trainer 142 and subprocess model trainer 144, which may operate as described with reference to FIG. 1. For example, main process model trainer 142 can be configured to generate or train main process model 122. Similarly, subprocess model trainer 144 can be configured to generate or train subprocess model 124. In some embodiments, model generator 140 includes multiple instances of main process model trainer 142 and/or subprocess model trainer 144. Each instance of main process model trainer 142 may correspond to a different main process model 122 and can be used for embodiments in which controller 120 includes multiple main process models 122. Each instance of subprocess model trainer 144 may correspond to a different subprocess model 124 (e.g., one of subprocess models 124a-124n) and can be used for embodiments in which controller 120 includes multiple subprocess models 124a-124n (e.g., the embodiments of FIGS. 2-5C). For ease of explanation, FIG. 6 will be described for the scenario in which controller 120 requires a single main process model 122 and a single subprocess model 124 with the understanding that the same or similar features can be used to train multiple main process models and/or multiple subprocess models.

Model generator 140 can be configured to perform a system identification process to train main process model 122 and subprocess model 124. The classical problem of system identification involves predicting a future state vector xₜ₊₁ given the existing state xₜ of plant 110 and control action uₜ vectors. Historical data of the state xₜ and control action uₜ can be stored in historical database 130 and used for offline learning. Oftentimes the relation xₜ₊₁ (xₜ, uₜ) is difficult to learn directly due to the presence of noise. In that case, it is useful to predict a finite horizon of the resulting states. That is, given an initial state x₀ and the control actions u₀, . . . , uₙ₋₁, predict all states x₁, . . . , xₙ.

As discussed above, the state xₜ of plant 110 at time t can be defined as the states of the FVs and the CVs at time t. That is, xₜ=(fₜ, cₜ). The values of the CVs depend on the values of the FVs, but the values of the FVs do not depend on the values of the CVs. This unidirectional causal relationship between the FVs and the CVs is referred to as hierarchical and can be leveraged to address an issue that arises in system identification which might lead to compromised predictions of the CVs in some scenarios if not appropriately handled. For example, if the function cₜ₊₁=C(cₜ, fₜ, uₜ) is trained using the values of the FVs generated by subprocess model 124 instead of the historical values of the FVs stored in historical database 130, the function C would not account for unpredictable process noise ξ in subprocess 116 which causes the historical values of the FVs to deviate from the values of the FVs predicted by subprocess model 124. As an example, in the case where fₜ₊₁=F(fₜ, uₜ)+ ξ where F is a function representing subprocess 116 and ξ is unpredictable process noise in subprocess 116, even if subprocess model 124 learns the function F perfectly, the values of fₜ predicted by subprocess model 124 will not be the same as the values of fₜ in the historical data because the values of fₜ predicted by subprocess model 116 do not account for the unpredictable process noise ξ. Accordingly, training main process model 122 using values of fₜ predicted by subprocess model 116 instead of the actual values of fₜ in the historical data might lead to main process model 122 learning an incorrect relationship between fₜ and cₜ.

Advantageously, model generator 140 can be configured to train main process model 122 and subprocess model 124 in a manner that leverages the hierarchical or causal structure of the corresponding processes in plant 110. For example, model generator 140 can be configured to independently train main process model 122 and subprocess model 124 using the historical data in historical database 130 rather than using the predicted values of the FVs from subprocess model 124 to train main process model 122. The training process can be performed offline using the historical data. Once main process model 122 and subprocess model 124 are trained, the trained models 122 and 124 can be provided to controller 120 and used for process prediction during online or real-time operation of plant 110 (e.g., for control schemes such as MPC in which models 122 and 124 are used during online operation of plant 110). During online operation the predicted values of the FVs from subprocess model 124 can be provided as inputs to main process model 122, whereas during the offline training phase both models 122 and 124 can be trained independently from the historical data. In other embodiments such as the DLPC schemes described in the '227 application, models 122 and 124 can be used offline to train a controller neural network which is then used during online operation of plant 110.

The offline training phase includes a first stage in which subprocess model trainer 144 trains subprocess model 124 and a second stage in which main process model trainer 142 trains main process model 122. The first stage and second stage can occur in any order or concurrently in various embodiments. The first and second stages of the offline training process can be performed independently because the predicted values of the FVs generated by subprocess model 124 during the first stage (i.e. subprocess model training) are not used as inputs to the second stage (i.e., main process model training). Rather, the main process model training performed by main process model trainer 142 relies exclusively on the historical data from historical database 130 (e.g., historical values of the FVs, CVs, and MVs) and the predicted values of the CVs generated by main process model 122.

In some embodiments, in the first stage of the offline training process, subprocess model trainer 144 trains subprocess model 124 to predict the FVs fₜ₊₁=F(fₜ, uₜ) on a finite time horizon. In various other embodiments, the function F used in the first stage of the offline training process may receive as inputs the values of the FVs, control actions u, and/or disturbances d at time t and/or during a window of time leading up to time t. The first iteration of the training process performed by subprocess model trainer 144 includes initializing subprocess model 124 with an initial state of the FVs f₀ from historical database 130, where f₀ denotes the values of the FVs at time t₀. Subprocess model trainer 144 may retrieve the corresponding values of the control actions u₀ from historical database 130 for the same time t₀. Subprocess model trainer 144 may provide the initial values of f₀ and u₀ as inputs to subprocess model 124 to predict the values of the FVs f₁ at time t₁ according to the relationship defined by subprocess model 124 (e.g., fₜ₊₁=F(fₜ, uₜ)).

Each subsequent iteration of the training process performed by subprocess model trainer 144 may be similar to the first iteration, with the exception that the predicted values of the FVs from the previous iteration are used as the state of the FVs instead of using the historical values of the FVs from historical database 130. For example, for the second iteration, subprocess model trainer 144 uses the predicted values of the FVs f₁ at time t from the first iteration as inputs to subprocess model 124 along with historical values of the control actions u at time t₁ from historical database 130. Subprocess model trainer 144 may provide the values of f₁ and u₁ as inputs to subprocess model 124 to predict the values of the FVs f₂ at time t₂ according to the relationship defined by subprocess model 124 (e.g., fₜ₊₁=F(fₜ, uₜ)). Subprocess model trainer 144 may repeat this process iteratively, advancing forward in time with each iteration, until reaching the end of the finite time horizon at time tₙ.

Upon reaching time tₙ, subprocess model trainer 144 will have generated predicted values of the FVs for each time t₁ . . . tₙ (i.e., f₁ . . . fₙ). Subprocess model trainer 144 may then compare the predicted values f₁ . . . fₙ of the FVs with the actual historical values of the FVs from historical database 130. Subprocess model trainer 144 may then adjust the trainable parameters of subprocess model 124 (e.g., model coefficients, weights between neurons of a neural network model, etc.) to minimize the deviation between the predicted values f₁ . . . fₙ of the FVs generated by subprocess model 124 and the corresponding actual historical values of the FVs from historical database 130 for the same times t₁ . . . tₙ. The first stage of the offline training process may be repeated until subprocess model trainer 144 determines that subprocess model 124 is sufficiently accurate, for example, in response to determining that the error between the predicted values f₁ . . . fₙ relative to the actual historical values is below a threshold or after performing a minimum number of cycles of the first stage.

In some embodiments, in the second stage of the offline training process, main process model trainer 142 trains main process model 122 to predict the CVs cₜ₊₁=C(cₜ, fₜ, uₜ) on a finite time horizon. In various other embodiments, the function C used in the second stage of the offline training process may receive as inputs the values of the CVs, the values of the FVs, control actions u, and/or disturbances d at time t and/or during a window of time leading up to time t. The first iteration of the training process performed by main process model trainer 142 includes initializing main process model 122 with an initial state of the CVs c₀ from historical database 130, where c₀ denotes the values of the CVs at time t₀. Main process model trainer 142 may retrieve the corresponding values of the control actions u₀ and the FVs f₀ from historical database 130 for the same time t₀. Main process model trainer 142 may provide the initial values of c₀, f₀, and u₀ as inputs to main process model 122 to predict the values of the CVs c₁ at time t₁ according to the relationship defined by main process model 122 (e.g., cₜ₊₁=C(cₜ, fₜ uₜ)).

Each subsequent iteration of the training process performed by main process model trainer 142 may be similar to the first iteration, with the exception that the predicted values of the CVs from the previous iteration are used as the state of the CVs instead of using the historical values of the CVs from historical database 130. For example, for the second iteration, main process model trainer 142 uses the predicted values of the CVs c₁ at time t₁ from the first iteration as inputs to main process model 122 along with historical values of the FVs f₁ and the control actions u at time t₁ from historical database 130. Main process model trainer 142 may provide the values of c₁, f₁, and u₁ as inputs to main process model 122 to predict the values of the CVs c₂ at time t₂ according to the relationship defined by main process model 122 (e.g., cₜ₊₁=C(cₜ, fₜ, uₜ)). Main process model trainer 142 may repeat this process iteratively, advancing forward in time with each iteration, until reaching the end of the finite time horizon at time tₙ.

Upon reaching time tₙ, main process model trainer 142 will have generated predicted values of the CVs for each time t₁ . . . tₙ (i.e., c₁ . . . cₙ). Main process model trainer 142 may then compare the predicted values c₁ . . . cₙ of the CVs with the actual historical values of the CVs from historical database 130. Main process model trainer 142 may then adjust the trainable parameters of main process model 122 (e.g., model coefficients, weights between neurons of a neural network model, etc.) to minimize the deviation between the predicted values c₁ . . . cₙ of the CVs generated by main process model 122 and the corresponding actual historical values of the CVs from historical database 130 for the same times t₁ . . . tₙ. The second stage of the offline training process may be repeated until main process model trainer 142 determines that main process model 122 is sufficiently accurate, for example, in response to determining that the error between the predicted values c₁ . . . cₙ relative to the actual historical values is below a threshold or after performing a minimum number of cycles of the second stage. In some embodiments, the second stage of the offline training process uses the form of main process model 122 cₜ₊₁=C(cₜ, fₜ₊₁, uₜ) instead of the form C+1=C(cₜ, fₜ, uₜ). After completing the second stage of the offline training process, both main process model 122 and subprocess model 124 are trained and can be provided to controller 120 for use in online control of plant 110 (i.e., for online process prediction).

Controller 120 can use main process model 122 and subprocess model 124 to control the operation of plant 110 in the manner described with reference to FIGS. 1-4. However, unlike the offline training processes performed by model generator 140, controller 120 can link the outputs of subprocess model 124 to the inputs of main process model 122 during the prediction phase such that the predicted values of the CVs generated by main process model 122 are based on the predicted values of the FVs generated by subprocess model 124. For example, controller 120 may initialize subprocess model 124 using initial values of the FVs f₀ and initial values of the control actions u₀. The initial values f₀ may be actual or predicted values of the FVs for time t₀ (e.g., received as feedback from plant 110, generated by controller 120, or received from historical database 130), whereas the initial values of the control actions u₀ can be the values of the control actions provided as input to plant 110 at time t₀. Controller 120 may provide the initial values of f₀ and u₀ as inputs to subprocess model 124 to predict the values of the FVs f₁ at time t₁ according to the relationship defined by subprocess model 124 (e.g., fₜ₊₁=F(fₜ, uₜ)).

Each subsequent iteration of the prediction process performed by controller 120 may be similar to the first iteration, with the exception that the predicted values of the FVs f₁ from the previous iteration are used as the state of the FVs instead of using the initial values of the FVs f₀. For example, for the second iteration, controller 120 uses the predicted values of the FVs f₁ at time t₁ from the first iteration as inputs to subprocess model 124 along with actual or planned values of the control actions u₁ at time t₁. Controller 120 may provide the values of f₁ and u₁ as inputs to subprocess model 124 to predict the values of the FVs f₂ at time t₂ according to the relationship defined by subprocess model 124 (e.g., fₜ₊₁=F(fₜ, uₜ)). Controller 120 may repeat this process iteratively, advancing forward in time with each iteration, until reaching the end of the finite time horizon at time tₙ. Upon reaching time ty, controller 120 will have generated predicted values of the FVs for each time t₁ . . . tₙ (i.e., f₁ . . . fₙ). As used herein, the notation t₁ . . . tₙ refers to a series of time points that have an increment of one unit of time (e.g., one second, one minute, one fifteen-minute interval, one hour, one day, etc.) between consecutive time points such that t₂=t₁₊1, t₃=t₂₊1, etc. and the “+1” notation indicates the addition of one unit of time.

Similarly, controller 120 may initialize main process model 122 using initial values of the FVs f₀, initial values of the CVs c₀, and initial values of the control actions u₀. The initial values f₀ and c₀ may be actual or predicted values of the FVs and CVs for time t₀ (e.g., received as feedback from plant 110 or generated by controller 120), whereas the initial values of the control actions u₀ can be the values of the control actions provided as input to plant 110 at time t₀. Controller 120 may provide the initial values of f₀, c₀, and u₀ as inputs to main process model 122 to predict the values of the CVs c₁ at time t₁ according to the relationship defined by main process model 122 (e.g., cₜ₊₁=C(cₜ, fₜ, uₜ)).

Each subsequent iteration of the prediction process performed by controller 120 may be similar to the first iteration, with the exception that the predicted values of the CVs from the previous iteration and the predicted values of the FVs from the previous iteration are used as the states of the CVs and the FVs respectively. For example, for the second iteration, controller 120 uses the predicted values of the CVs c₁ from main process model 122 and the predicted values of the FVs f₁ from subprocess model 124 at time t₁ from the first iteration as inputs to main process model 122 along with values of the control actions u₁ at time t₁ (e.g., actual or planned values of the control actions for time t₁). Controller 120 may provide the values of c₁, f₁, and u₁ as inputs to main process model 122 to predict the values of the CVs c₂ at time t₂ according to the relationship defined by main process model 122 (e.g., cₜ₊₁=C(cₜ, fₜ, uₜ)). Controller 120 may repeat this process iteratively, advancing forward in time with each iteration, until reaching the end of the finite time horizon at time tₙ. Upon reaching time ty, controller 120 will have generated predicted values of the CVs for each time t₁ . . . tₙ (i.e., c₁ . . . cₙ), where t₁ . . . tₙ refers to a series of time points that have an increment of one unit of time (e.g., one second, one minute, one fifteen-minute interval, one hour, one day, etc.) between consecutive time points as noted above.

Alternatively, for an embodiment in which main process model 122 is formulated as cₜ₊₁=C(cₜ, fₜ₊₁, uₜ), controller 120 may initialize main process model 122 using the predicted values of the FVs f₁ generated by subprocess model 124 during the first iteration of the subprocess prediction performed by controller 120, along with the initial values of the CVs c₀ and initial values of the control actions u₀ as previously described. Controller 120 may provide the values of f₁, c₀, and u₀ as inputs to main process model 122 to predict the values of the CVs c₁ at time t₁ according to the relationship defined by main process model 122 (e.g., cₜ₊₁=C(cₜ, +fₜ₊₁, uₜ)).

Each subsequent iteration of the prediction process performed by controller 120 may be similar to the first iteration, with the exception that the predicted values of the CVs from the previous iteration and the predicted values of the FVs from the previous iteration are used as the states of the CVs and the FVs respectively. For example, for the second iteration, controller 120 uses the predicted values of the CVs c₁ from main process model 122 at time t₁ and the predicted values of the FVs f₂ from subprocess model 124 at time t₂ as inputs to main process model 122 along with values of the control actions u₁ at time t₁ (e.g., actual or planned values of the control actions for time t₁). Controller 120 may provide the values of c₁, f₂, and u₁ as inputs to main process model 122 to predict the values of the CVs c₂ at time t₂ according to the relationship defined by main process model 122 (e.g., cₜ₊₁=C(cₜ, fₜ₊₁, uₜ)). Controller 120 may repeat this process iteratively, advancing forward in time with each iteration, until reaching the end of the finite time horizon at time tₙ. Upon reaching time ty, controller 120 will have generated predicted values of the CVs for each time t₁ . . . tₙ (i.e., c₁ . . . cₙ), where t₁ . . . tₙ refers to a series of time points that have an increment of one unit of time between consecutive time points as noted above.

As discussed above, although main process model 122 and subprocess model 124 are described as cₜ₊₁=C(cₜ, fₜ₊₁, uₜ) and fₜ₊₁=F(fₜ, uₜ) respectively in the description of FIG. 6, it is contemplated that each model 122 and 124 can also receive values of the disturbance variables dₜ as inputs and/or can receive as inputs a time window of values of each input variable leading up to time t in addition to the values of the input variables at time t. It should be understood that the specific examples of main process model 122 and subprocess model 124 described herein are illustrative only and do not limit the scope or applicability of the systems and methods of the present disclosure.

### Hierarchical System Identification and Control Process

Referring now to FIG. 7, a flowchart of a hierarchical system identification process 200 is shown, according to an exemplary embodiment. Process 200 can be performed by various components of control system 100 including plant 110, controller 120, historical database 130, and/or model generator 140 in some embodiments. The steps of process 200 may be executed using the same or similar techniques as described with reference to FIGS. 1-6. In some embodiments, steps 202-206 are performed offline by model generator 140 to generate or train subprocess model 124 and main process model 122. Steps 208-212 may be performed online by controller 120 to control operation of plant 110.

Process 200 is shown to include obtaining historical values of forecast variables (FVs), controlled variables (CVs), and manipulated variables (MVs) (step 202). The historical values of the FVs, CVs, and MVs may be obtained from historical database 130 and may include the values of fₜ, cₜ, and uₜ respectively for a predetermined historical time period (e.g., from to, . . . tₙ). The CVs may include one or more variables that can be controlled by operating plant 110 and contribute to a reward function J (e.g., an objective function, a cost function, a value function, etc.). In some embodiments, the CVs represent the outputs of plant 110 and are affected by the process represented by plant 110. The FVs may include one or more variables that are not included in the reward function J but may be useful for obtaining predictions of the CVs. For example, the FVs may be part of a subsystem of plant 110 such that the FVs affect the CVs but are not affected by the CVs. Alternatively, the FVs may include one or more variables that are included in the reward function J in some embodiments. Both the values of the CVs and the values of the FVs may be affected by the MVs provided as inputs to plant 110. Further, the values of the CVs may be affected by the values of the FVs. However, the causal relationship between the FVs and the CVs may be unidirectional such that the values of the CVs do not affect the values of the FVs.

Process 200 is shown to include training a subprocess model using the historical values of the FVs and the MVs (step 204). In some embodiments, step 204 is performed by subprocess model trainer 144 as described with reference to FIG. 6. In various embodiments, step 204 may include training a single subprocess model (e.g., subprocess model 124) as shown in FIG. 2 or multiple subprocess models (e.g., subprocess models 124a-124n) as shown in FIGS. 3-4. Step 204 may include training subprocess model 124 to predict the FVs fₜ₊₁=F(fₜ, uₜ) on a finite time horizon. The training process in step 204 may be an iterative training process including multiple iterations. In some embodiments, the first iteration in step 204 includes initializing subprocess model 124 with an initial state of the FVs (e.g., f₀) from historical database 130, where f₀ denotes the values of the FVs at time t₀. Step 204 may include retrieving the corresponding values of the MVs (e.g., the control actions u₀) from historical database 130 for the same time t₀. Step 204 may include providing the initial values of f₀ and u₀ as inputs to subprocess model 124 to predict the values of the FVs f₁ at time t₁ according to the relationship defined by subprocess model 124 (e.g., fₜ₊₁=F(fₜ, uₜ)).

Each subsequent iteration in step 204 may be similar to the first iteration, with the exception that the predicted values of the FVs from the previous iteration are used as the state of the FVs instead of using the historical values of the FVs from historical database 130. For example, for the second iteration, step 204 may include using the predicted values of the FVs f₁ at time t₁ from the first iteration as inputs to subprocess model 124 along with historical values of the control actions u₁ at time t₁ from historical database 130. Step 204 may include providing the values of f₁ and u₁ as inputs to subprocess model 124 to predict the values of the FVs f₂ at time t₂ according to the relationship defined by subprocess model 124 (e.g., fₜ₊₁=F(fₜ, uₜ)). Step 204 may include repeating this process iteratively, advancing forward in time with each iteration, until reaching the end of the finite time horizon at time tₙ.

Upon reaching time ty, step 204 will have generated predicted values of the FVs for each time t₁ . . . tₙ (i.e., f₁ . . . fₙ). Step 204 may include comparing the predicted values f₁ . . . fₙ of the FVs with the actual historical values of the FVs from historical database 130. Step 204 may include adjusting the trainable parameters of subprocess model 124 (e.g., model coefficients, weights between neurons of a neural network model, etc.) to minimize the deviation between the predicted values f₁ . . . fₙ of the FVs generated by subprocess model 124 and the corresponding actual historical values of the FVs from historical database 130 for the same times t₁ . . . tₙ. In some embodiments, step 204 may be repeated multiple times until subprocess model trainer 144 determines that subprocess model 124 is sufficiently accurate, for example, in response to determining that the error between the predicted values f₁ . . . fₙ relative to the actual historical values is below a threshold or after performing a minimum number of cycles of step 204.

For embodiments in which step 204 includes training multiple subprocess models (e.g., subprocess models 124a-124n), each of subprocess models 124a-124n may be trained independently using historical values of the MVs provided as inputs to the corresponding subprocesses 116a-116n and historical values of the FVs generated as outputs of the corresponding subprocesses 116a-116n. The historical values of the FVs may be used to define the initial state f₀ of each subprocess model 124a-124n but not otherwise used as inputs to subprocess models 124a-124n during training. However, the historical values of the FVs may be used to determine the prediction error of each subprocess model 124a-124n by comparing the set of predicted values f₁ . . . fₙ from each subprocess model 124a-124n with the corresponding historical values of the FVs from historical database 130.

Process 200 is shown to include independently training a main process model using historical values of the CVs, the FVs, and the MVs, without using predicted values of the FVs from the subprocess model (step 206). In some embodiments, step 206 is performed by main process model trainer 142 as described with reference to FIG. 6. The main process model training in step 206 is an independent training process in that it does not depend on the subprocess model training in step 204 or rely on any of the predictions made by subprocess model 124 (e.g., predicted values of the FVs). Rather, the values of the FVs used in step 206 are historical values of the FVs obtained from historical database 130. In some embodiments, step 206 includes training multiple main process models 122 for embodiments in which plant 110 is modeled as including multiple main processes 118.

Step 206 may include training main process model 122 to predict the CVs cₜ₊₁=C(cₜ, fₜ, uₜ) on a finite time horizon. The training process in step 206 may be an iterative training process including multiple iterations. The first iteration of step 206 includes initializing main process model 122 with an initial state of the CVs c₀ from historical database 130, where c₀ denotes the values of the CVs at time t₀. Step 206 may include retrieving the corresponding values of the control actions u₀ and the FVs f₀ from historical database 130 for the same time t₀. Step 206 may include providing the initial values of c₀, f₀, and u₀ as inputs to main process model 122 to predict the values of the CVs c₁ at time t₁ according to the relationship defined by main process model 122 (e.g., cₜ₊₁=C(cₜ, fₜ, uₜ)). Alternatively, step 206 may use the form of main process model 122 cₜ₊₁=C(cₜ, fₜ₊₁, uₜ) instead of the form C++ 1=C(cₜ, fₜ, uₜ) as described above.

Each subsequent iteration of step 206 may be similar to the first iteration, with the exception that the predicted values of the CVs from the previous iteration are used as the state of the CVs instead of using the historical values of the CVs from historical database 130. For example, for the second iteration, step 206 may include using the predicted values of the CVs c₁ at time t₁ from the first iteration as inputs to main process model 122 along with historical values of the FVs f₁ and the control actions u₁ at time t₁ from historical database 130. Step 206 may include providing the values of c₁, f₁, and u₁ as inputs to main process model 122 to predict the values of the CVs c₂ at time t₂ according to the relationship defined by main process model 122 (e.g., cₜ₊₁=C(cₜ, fₜ, uₜ)). Alternatively, if main process model 122 is structured as cₜ₊₁=C(cₜ) fₜ₊₁, uₜ), step 206 may include providing the values of c₁, f₂, and u₁ as inputs to main process model 122 to predict the values of the CVs c₂ at time t₂. Main process model trainer 142 may repeat this process iteratively, advancing forward in time with each iteration, until reaching the end of the finite time horizon at time tₙ. For embodiments in which plant 110 includes multiple main processes 118, main process model trainer 142 may repeat step 206 to train a main process model 122 for each of the main processes 118.

Upon reaching time tₙ, step 206 will have generated predicted values of the CVs for each time t₁ . . . tₙ (i.e., c₁ . . . cₙ). Step 206 may include comparing the predicted values c₁ . . . cₙ of the CVs with the actual historical values of the CVs from historical database 130. Step 206 may include adjusting the trainable parameters of main process model 122 (e.g., model coefficients, weights between neurons of a neural network model, etc.) to minimize the deviation between the predicted values c₁ . . . cₙ of the CVs generated by main process model 122 and the corresponding actual historical values of the CVs from historical database 130 for the same times t₁ . . . tₙ. Step 206 may be repeated until main process model trainer 142 determines that main process model 122 is sufficiently accurate, for example, in response to determining that the error between the predicted values c₁ . . . cₙ relative to the actual historical values is below a threshold or after performing a minimum number of cycles of step 206. After completing step 206, both main process model 122 and subprocess model 124 are trained and can be provided to controller 120 for use in online control of plant 110 (i.e., for online process prediction).

Process 200 is shown to include using the subprocess model to predict future values of the FVs based on future values of the MVs (step 208). In some embodiments, step 208 is performed by controller 120 during online operation of plant 110. Step 208 may include generating a proposed trajectory of the MVs over a given time period (e.g., a timeseries of the control actions uₜ for each time step within the time period) and providing the MVs as inputs to subprocess model 124. Step 208 may include using subprocess model 124 to predict the values of the FVs that will result from the trajectory of MVs provided as inputs to subprocess model 124 according to the relationship fₜ₊₁=F(fₜ, uₜ) provided by subprocess model 124. The values of the MVs provided as inputs to subprocess model 124 in step 208 may include values of the MVs that are being considered by controller 120 for use in operating plant 110. Controller 120 can freely adjust the values of the MVs when performing step 208. The values of fₜ provided as inputs to subprocess model 124 in step 208 may include the predicted values of the FVs from the previous iteration of step 208. For example, the control actions u₁ and the FVs f₁ at time t₁ can be provided as inputs to subprocess model 124 to predict the values of the FVs f₂ at time t₂. The values of the FVs at time t₂ can then be provided as inputs to subprocess model 124 along with the values of the MVs at time t₂ to predict the values of the FVs at time t₃. This process can be repeated until controller 120 has generated predicted values of the FVs f₁ . . . fₙ for each time t₁ . . . tₙ. As noted above, the notation t₁ . . . tₙ refers to a series of time points that have an increment of one unit of time (e.g., one second, one minute, one fifteen-minute interval, one hour, one day, etc.) between consecutive time points such that t₂=t₁₊1, t₃=t₂₊1, etc. and the “+1” notation indicates the addition of one unit of time.

For embodiments in which subprocess model 124 includes multiple subprocess models 124a-124n, the prediction in step 208 may vary depending on the structure of the subprocess models 124a-124n. If subprocess models 124a-124n are arranged in series with each other as shown in FIG. 3, step 208 can be performed as described with reference to FIG. 3. For example, step 208 may include using subprocess A model 124a to predict a first set of FVs fₐ according to the relationship f_{a,t+1}=Fₐ(f_{a,t}, uₜ) such that the control actions uₜ and the forecast variables f_{a,t} at time t affect the predicted values of the forecast variables f_{a,t+1} at time t+1 output by subprocess A model 124a. Step 208 may then use subprocess B model 124b to predict a second set of FVs f_{b} according to the relationship f_{b,t+1}=F_{b}(f_{b,t}, uₜ, f_{a,t}) or f_{b,t+1}=F_{b}(f_{b,t}, uₜ, f_{a,t+1}) such that the outputs of subprocess A model 124a for time t (i.e., fat) or time t+1 (i.e., f_{a,t+1}) are provided as inputs to subprocess B model 124b. This sequential operation of subprocess models 124a-124n may continue until subprocess N model 124n is used to predict the n'th set of FVs fₙ. The result of these subprocess predictions in step 208 may produce multiple sets of FVs, with each set of FVs having predicted values for each time step t₁ . . . tₙ.

Alternatively, if subprocess models 124a-124n are arranged in parallel with each other as shown in FIG. 4, step 208 can be performed as described with reference to FIG. 4. For example, step 208 may include using each of subprocess models 124a-124n independently to predict the corresponding set of FVs provided as outputs of each subprocess model 124a-124n. In this scenario, the predictions performed by each subprocess model 124a-124n in step 208 may be independent of each other because the outputs of one subprocess model (e.g., subprocess A model 124a) are not provided as inputs to other subprocess models (e.g., subprocess B model 124b). Rather, all of the outputs of subprocess models 124a-124n may be provided in parallel to main process model 122.

Process 200 is shown to include using the main process model to predict future values of the CVs based on the values of the FVs predicted by the subprocess model (step 210). In some embodiments, step 210 is performed by controller 120 during online operation of plant 110. Step 210 may include generating a proposed trajectory of the MVs over a given time period (e.g., a timeseries of the control actions uₜ for each time step within the time period) and providing the MVs as inputs to main process model 122 along with the predicted values of the FVs generated in step 208. Step 210 may include using main process model 122 to predict the values of the CVs that will result from the trajectory of MVs and FVs provided as inputs to main process model 122 according to the relationship cₜ₊₁=C(cₜ, fₜ, uₜ) such that the values of the MVs (e.g., the control actions uₜ) at time t, the CVs cₜ at time t, and the FVs fₜ at time t affect the predicted values of the CVs cₜ₊₁ at time t+1. Alternatively, if main process model 122 has the form cₜ₊₁=C(cₜ, fₜ₊₁, uₜ), step 210 may include using the values of the MVs (e.g., the control actions uₜ) at time t, the CVs cₜ at time t, and the FVs fₜ₊₁ at time t+1 to predict the values of the CVs cₜ₊₁ at time t+1.

For embodiments in which multiple subprocess models 124a-124n are used, the predictions in step 210 may vary depending on whether subprocess models 124a-124n are arranged in series as shown in FIG. 3, in parallel as shown in FIG. 4, in a series/parallel combination, or any other arrangement of subprocess models 124a-124n. If subprocess models 124a-124n are arranged in series, the predictions in step 210 may be performed as described with reference to FIG. 3. For example, the predicted values of the forecast variables f_{n,t} at time t or f_{n,t+1} at time t+1 generated by the final sequential subprocess model (e.g., subprocess N model 124n) can be provided as inputs to main process model 122. Step 210 can include using main process model 122 to predict the values of the CVs output by main process 118 according to the relationship cₜ₊₁=C(cₜ, f_{n,t}, uₜ) or cₜ₊₁=C(cₜ, f_{n,t+1}, uₜ), such that the control actions uₜ at time t, the controlled variables cₜ at time t, and the forecast variables f_{n,t} at time t or f_{n,t+1} at time t+1 output by the final subprocess model 124n affect the predicted values of the controlled variables cₜ₊₁ at time t+1.

Alternatively, if subprocess models 124a-124n are arranged in parallel, the predictions in step 210 may be performed as described with reference to FIG. 4. In this scenario, step 210 may include providing the outputs of subprocess models 124a-124n as parallel inputs to main process model 122. For example, the predicted values of the forecast variables f_{a,t} f_{b,t}, . . . , f_{n,t} at time t and/or f_{a,t+1}, f_{b,t+1}, . . . , f_{n,t+1} at time t+1 generated by subprocess models 124a-124n can all be provided as inputs to main process model 122. Main process model 122 can be expressed as cₜ₊₁=C(cₜ, f_{a,t}, f_{b,t}, . . . f_{n,t}, uₜ), C+1=C(cₜ, f_{a,t+1}, f_{b,t+1}, . . . , f_{n,t+1}, uₜ), or a combination or mixture thereof (e.g., some of the FV values input to main process model 122 are taken at time t and other FV values input to main process model 122 are taken at time t+1) such that the control actions uₜ at time t, the controlled variables cₜ at time t, and the forecast variables f_{a,t}, f_{b,t}, . . . , f_{n,t} at time t and/or f_{a,t+1}, f_{b,t+1}, . . . , f_{n,t+1} at time t+1 output by subprocess models 124a-124n affect the predicted values of the controlled variables cₜ₊₁ at time t+1.

Process 200 is shown to include controlling operation of the plant based on the future values of the CVs predicted by the main process model (step 212). In some embodiments, step 212 includes evaluating a reward function J using the future values of the CVs predicted by main process model 122 in step 210. The reward function J quantifies the performance of plant 110 as a function of the CVs (and in some cases other variables in addition to the CVs) and may define one or more objectives which controller 120 seeks to minimize or maximize. For example, the reward function J may quantify a total cost of operating equipment 112 (e.g., electricity cost, the cost of input materials, etc.), a total value of the outputs produced by equipment 112 (e.g., a value of one or more oil products), an energy consumption of plant 110, an error between the outputs of plant 110 and target values, or any other function which can be used to quantify the performance of plant 110.

In some embodiments, the value of the reward function J at a given time t is based on the values of the CVs at that same time t (e.g., Jₜ=f(c_{1,t}, c_{2,t}, . . . , c_{n,t}), where n is the total number of CVs included in the reward function J and the variables c_{1,t}, c_{2,t}, . . . , c_{n,t} are the values of the CVs at time t). In other embodiments, the value of the reward function J may be based on the values of the CVs over a predetermined time period including multiple time steps t (e.g., J=Σ_{t′=t}^{t+k}f(c_{1,t′}, c_{2,t′}, . . . , c_{n,t′}), where k is the total number of time steps t included in the time period over which the reward function J is evaluated. Step 212 may include adjusting the values of the MVs in the proposed trajectory of MVs and repeating steps 208-210 to predict the values of the FVs and the CVs that will result from the adjusted trajectory of MVs over the given time period. The newly predicted values of the CVs can then be provided as inputs to the reward function J to calculate the value of the reward function J. This process may be repeated iteratively to drive the reward function J toward an extremum (e.g., a maximum or minimum).

Step 212 may include using the values of the MVs (e.g., the original or adjusted values of the MVs) to control operation of plant 110. Step 212 may include providing plant 110 with control signals, setpoints, operating commands, or other inputs based on the values of the MVs to adjust the operation of equipment 112. Step 212 may include activating one or more devices of equipment 112, deactivating one or more devices of equipment 112, causing equipment 112 to change their operating mode or state, or otherwise causing changes to the operation of equipment 112. The control operations performed in step 212 may cause changes in the physical state or condition of plant 110 or otherwise affect the physical operations performed by equipment 112. For example, the control operations may affect the transformation of an input resource (e.g., oil, raw petroleum products, etc.) into a different type of resource (e.g., gasoline, petrol, kerosene, jet fuel, etc.) having a different physical form or chemical composition by changing the operation of equipment 112. Although only a few examples of specific control operations are described herein, it is contemplated that step 212 may include any type of control operation as may be suitable for controlling the operation of plant 110, which may vary depending on the type or purpose of equipment 112 and plant 110 in various embodiments.

In some embodiments, controlling operation of the plant in step 212 includes using the values of the CVs predicted by the main process model to train a controller neural network as described in the '227 application. For example, the CV predictions output by the main process model can be used in the same manner as the CV predictions output by the predictor neural network shown in FIG. 7 of the '227 application. That is, the CV predictions can be used to adjust the weights of a controller neural network as described with reference to FIG. 7 in the '227 application. In this embodiment, step 212 may be performed offline to train the controller neural network. The trained controller neural network can then be used online to control operation of the plant during online operation. As used herein, the phrase “executing a predictive control process” may refer to some or all of the steps of process 200 including both the offline training phase of the predictive control process (e.g., training the subprocess model, main process model, and/or controller neural network) and the online operation phase of the predictive control process (e.g., using the trained subprocess model, main process model, and/or controller neural network to generate control decisions or MV values for use in controlling operation of the plant) and is not necessarily limited to only the online operation phase.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A predictive control system for a plant comprising a subprocess and a main process affected by the subprocess, the predictive control system comprising:
a model generator configured to:
obtain historical values of one or more forecast variables representing one or more outputs of the subprocess, historical values of one or more controlled variables representing one or more outputs of the main process, and historical values of one or more manipulated variables representing one or more inputs to the plant;
train a subprocess model representing the subprocess using the historical values of the one or more forecast variables and the historical values of the one or more manipulated variables; and
train a main process model representing the main process using the historical values of the one or more controlled variables, the historical values of the one or more forecast variables, and the historical values of the one or more manipulated variables;
a controller configured to execute a predictive control process using the subprocess model and the main process model to control operation of the plant, the predictive control process comprising:
using the subprocess model to predict future values of the one or more forecast variables based on values of the one or more manipulated variables;
using the main process model to predict future values of the one or more controlled variables based on the future values of the one or more forecast variables predicted by the subprocess model; and
controlling operation of the plant based on the future values of the one or more controlled variables predicted by the main process model.

2. The predictive control system of claim 1, wherein:
the model generator is configured to independently train the main process model without using predictions generated by the subprocess model; and
the controller is configured to use the predictions generated by the subprocess model as inputs to the main process model when executing the predictive control process.

3. The predictive control system of claim 1, wherein controlling operation of the plant comprises:
evaluating a reward function using the future values of the one or more controlled variables predicted by the main process model;
adjusting the values of the one or more manipulated variables to drive the reward function toward an extremum; and
using the adjusted values of the one or more manipulated variables to control operation of the plant.

4. The predictive control system of claim 1, wherein:
the plant comprises a plurality of subprocesses and a plurality of main processes affected by the plurality of subprocesses;
the model generator is configured to train a plurality of subprocess models representing the plurality of subprocesses and a plurality of main process models representing the plurality of main processes; and
the controller is configured to use the plurality of subprocess models to predict future values of the one or more forecast variables representing outputs of the plurality of subprocesses and use the plurality of main process models to predict future values of the one or more controlled variables representing outputs of the plurality of main processes.

5. The predictive control system of claim 4, wherein the plurality of subprocesses are arranged in series with each other such that an output of a first subprocess of the plurality of subprocesses is provided as an input to a second subprocess of the plurality of subprocesses, wherein the controller is configured to:
use a first subprocess model of the plurality of subprocess models representing the first subprocess to predict future values of one or more first forecast variables representing one or more outputs of the first subprocess based on the values of the one or more manipulated variables;
use a second subprocess model of the plurality of subprocess models representing the second subprocess to predict future values of one or more second forecast variables representing one or more outputs of the second subprocess based on the future values of the one or more first forecast variables predicted by the first subprocess model; and
use the main process model to predict future values of the one or more controlled variables based on the future values of the one or more second forecast variables predicted by the second subprocess model.

6. The predictive control system of claim 4, wherein the plurality of subprocesses are arranged in parallel with each other such that a first output of a first subprocess of the plurality of subprocesses and a second output of a second subprocess of the plurality of subprocesses are provided as inputs to the main process, wherein the controller is configured to:
use a first subprocess model of the plurality of subprocess models representing the first subprocess to predict future values of one or more first forecast variables representing one or more outputs of the first subprocess based on the values of the one or more manipulated variables;
use a second subprocess model of the plurality of subprocess models representing the second subprocess to predict future values of one or more second forecast variables representing one or more outputs of the second subprocess based on the values of the one or more manipulated variables; and
use the main process model to predict future values of the one or more controlled variables based on the future values of the one or more first forecast variables predicted by the first subprocess model and the future values of the one or more second forecast variables predicted by the second subprocess model.

7. The predictive control system of claim 1, wherein controlling operation of the plant comprises:
using the values of the one or more controlled variables predicted by the main process model to train a controller neural network model during an offline training phase of the predictive control process; and
using the controller neural network model to generate values of the one or more manipulated variables during an online operation phase of the predictive control process.

8. A method for controlling operation of a plant comprising a subprocess and a main process affected by the subprocess, the method comprising:
obtaining historical values of one or more forecast variables representing one or more outputs of the subprocess, historical values of one or more controlled variables representing one or more outputs of the main process, and historical values of one or more manipulated variables representing one or more inputs to the plant;
training a subprocess model representing the subprocess using the historical values of the one or more forecast variables and the historical values of the one or more manipulated variables;
training a main process model representing the main process using the historical values of the one or more controlled variables, the historical values of the one or more forecast variables, and the historical values of the one or more manipulated variables;
executing a predictive control process using the subprocess model and the main process model to control operation of the plant, the predictive control process comprising:
using the subprocess model to predict future values of the one or more forecast variables based on values of the one or more manipulated variables;
using the main process model to predict future values of the one or more controlled variables based on the future values of the one or more forecast variables predicted by the subprocess model; and
controlling operation of the plant based on the future values of the one or more controlled variables predicted by the main process model.

9. The method of claim 8, wherein:
the main process model and the subprocess model are trained independently without using predictions generated by the subprocess model when training the main process model; and
the predictions generated by the subprocess model are used as inputs to the main process model when executing the predictive control process.

10. The method of claim 8, wherein controlling operation of the plant comprises:
evaluating a reward function using the future values of the one or more controlled variables predicted by the main process model;
adjusting the values of the one or more manipulated variables to drive the reward function toward an extremum; and
using the adjusted values of the one or more manipulated variables to control operation of the plant.

11. The method of claim 8, wherein:
the plant comprises a plurality of subprocesses and a plurality of main processes affected by the plurality of subprocesses;
training the subprocess model comprises training a plurality of subprocess models representing the plurality of subprocesses;
training the main process model comprises training a plurality of main process models representing the plurality of main processes; and
controlling operation of the plant comprises using the plurality of subprocess models to predict future values of the one or more forecast variables representing outputs of the plurality of subprocesses and using the plurality of main process models to predict future values of the one or more controlled variables representing outputs of the plurality of main processes.

12. The method of claim 11, wherein the plurality of subprocesses are arranged in series with each other such that an output of a first subprocess of the plurality of subprocesses is provided as an input to a second subprocess of the plurality of subprocesses, wherein the predictive control process comprises:
using a first subprocess model of the plurality of subprocess models representing the first subprocess to predict future values of one or more first forecast variables representing one or more outputs of the first subprocess based on the values of the one or more manipulated variables;
using a second subprocess model of the plurality of subprocess models representing the second subprocess to predict future values of one or more second forecast variables representing one or more outputs of the second subprocess based on the future values of the one or more first forecast variables predicted by the first subprocess model; and
using the main process model to predict future values of the one or more controlled variables based on the future values of the one or more second forecast variables predicted by the second subprocess model.

13. The method of claim 11, wherein the plurality of subprocesses are arranged in parallel with each other such that a first output of a first subprocess of the plurality of subprocesses and a second output of a second subprocess of the plurality of subprocesses are provided as inputs to the main process, wherein the predictive control process comprises:
using a first subprocess model of the plurality of subprocess models representing the first subprocess to predict future values of one or more first forecast variables representing one or more outputs of the first subprocess based on the values of the one or more manipulated variables;
using a second subprocess model of the plurality of subprocess models representing the second subprocess to predict future values of one or more second forecast variables representing one or more outputs of the second subprocess based on the values of the one or more manipulated variables; and
using the main process model to predict future values of the one or more controlled variables based on the future values of the one or more first forecast variables predicted by the first subprocess model and the future values of the one or more second forecast variables predicted by the second subprocess model.

14. The method of claim 8, wherein controlling operation of the plant comprises:
using the values of the one or more controlled variables predicted by the main process model to train a controller neural network model during an offline training phase of the predictive control process; and
using the controller neural network model to generate values of the one or more manipulated variables during an online operation phase of the predictive control process.

15. A predictive control system for a plant comprising a subprocess and a main process affected by the subprocess, the predictive control system comprising one or more processing circuits configured to:
independently train a subprocess model representing the subprocess and a main process model representing the main process without using predictions generated by the subprocess model when training the main process model;
after independently training the subprocess model and the main process model, connect the subprocess model to the main process model such that the predictions generated by the subprocess model are provided as inputs to the main process model;
execute a predictive control process using the subprocess model to generate predicted values of one or more forecast variables and using the main process model to generate predicted values of one or more controlled variables based on the predicted values of the one or more forecast variables generated by the subprocess model; and
control operation of the plant using the predicted values of the one or more controlled variables generated by the main process model.

16. The predictive control system of claim 15, wherein training the subprocess model comprises:
using historical values of one or more manipulated variables to generate predicted historical values of the one or more forecast variables using the subprocess model; and
adjusting the subprocess model to reduce an error between the predicted historical values of the forecast variables and actual historical values of the forecast variables.

17. The predictive control system of claim 15, wherein training the main process model comprises:
using historical values of the one or more forecast variables and historical values of one or more manipulated variables to generate predicted historical values of the one or more controlled variables using the main process model; and
adjusting the main process model to reduce an error between the predicted historical values of the controlled variables and actual historical values of the controlled variables.

18. The predictive control system of claim 15, wherein controlling operation of the plant comprises:
evaluating a reward function using the predicted values of the one or more controlled variables generated by the main process model;
adjusting values of one or more manipulated variables provided as inputs to the plant to drive the reward function toward an extremum; and
using the adjusted values of the one or more manipulated variables to control operation of the plant.

19. The predictive control system of claim 15, wherein:
training the subprocess model and the main process model comprises independently training a plurality of subprocess models representing a plurality of subprocesses of the plant and a plurality of main process models representing a plurality of main processes of the plant; and
connecting the subprocess model to the main process model comprises connecting a first subprocess model of the plurality of subprocess models and a second subprocess model of the plurality of subprocess models in series with each other and with one or more of the plurality of main process models such that:
a first output of the first subprocess model is provided as an input to the second subprocess model; and
a second output of the second subprocess model is provided as an input to the one or more of the plurality of main process models.

20. The predictive control system of claim 15, wherein:
training the subprocess model and the main process model comprises independently training a plurality of subprocess models representing a plurality of subprocesses of the plant and a plurality of main process models representing a plurality of main processes of the plant; and
connecting the subprocess model to the main process model comprises connecting a first subprocess model of the plurality of subprocess models and a second subprocess model of the plurality of subprocess models in parallel with each other and in series with one or more of the plurality of main process models such that:
a first output of the first subprocess model is provided as a first input to the one or more of the plurality of main process models; and
a second output of the second subprocess model is provided as a second input to the one or more of the plurality of main process models.
